(19) United States
(12) Patent Application Publication
(10) Pub. No.: US 2025/0315631 A1
(43) Pub. Date: Oct. 9, 2025

(54) FACE-TRANSLATOR: END-TO-END SYSTEM FOR SPEECH-TRANSLATED LIP-SYNCHRONIZED AND VOICE PRESERVING VIDEO GENERATION

(71) Applicant: Alexander Waibel, Sammamish, WA (US)

(72) Inventor: Alexander Waibel, Sammamish, WA (US)

(21) Appl. No.: 18/865,408

(22) PCT Filed: Apr. 14, 2023
(86) PCT No.: PCT/US2023/018581

§ 371 Date: Nov. 13, 2024

Related U.S. Application Data
(60) Provisional application No. 63/341,765, filed on May 13, 2022.
(60) Provisional application No. 63/365,922, filed on Jun. 6, 2022.

(51) Int. Cl. G06F 40/58; G06T 13/20; G06T 13/40; G10L 15/06; G10L 21/10

(52) U.S. Cl. CPC G06F 40/58; G06T 13/205; G06T 13/40; G10L 15/063; G10L 21/10; G10L 2021/105

(57) ABSTRACT

A neural end-to-end system is provided for the face and voice preserving translation of videos. The system is a pipeline of multiple models that produces a video of the original speaker speaking in the target language with modified lip movement to match the target speech, while preserving emphases and prosody of the original speech, and voice characteristics of the original speaker. The pipeline starts with automatic speech recognition including emphasis detection, followed by the translation model. The translated text is then synthesized by a Text-to-Speech model that recreates the original emphases in the target sentence. The resulting synthetic speech is then converted back to the original speakers' voice using a voice conversion model. Finally, to synchronize the lips of the speaker with the translated audio, a generative model generates frames of adapted lip movements which are combined with the audio to produce the final output. The disclosure further describes several use-cases and configurations that apply these techniques to video conferencing, dubbing, low-bandwidth transmission, speech enhancement and assistive technology for the hearing impaired.

### CROSS-REFERENCE TO RELATED APPLICATIONS

The present application claims priority to U.S. provisional application Ser. No. 63/341,765, filed May 13, 2022, and to U.S. provisional application Ser. No. 63/635,922, filed Jun. 6, 2022, both of which are incorporated herein by reference.

### BACKGROUND

Translation (or “interpretation” as it is called in the profession) of spoken language, can be automatically performed by today's Automatic Speech Recognition (ASR) technology, combined with automatic Machine Translation (MT) technology. The results are in many modern implementations text in one or more second (target) languages. In various embodiments these can then be displayed as text in output devices during simultaneously translated events or as subtitles or captions in video conferences or movies. This leaves the original experience, the audio-visual channel intact and provides a parallel channel to understand the content.

In many other use-cases, however, translated audio-visual output is desired and video dubbing is applied. Dubbing, so far, is generally produced humanly, by having human voice talents reading or acting out a voice script in a second target language in a way to that it best matches the original video that is to be dubbed. The process is slow, costly, labor intensive, and requires an edited script in the target language that more or less matches the same speaking rate as the video.

Isometric translation attempts to automatically generate translation that preserves certain timing constraints of speech, so that this matching by a voice talent can be done more convincingly. The term is thus mostly used to refer to machine translation with output lengths comparable to input lengths, so that the translation can be used in dubbing, where videos that were created in one language are matched with audio from a voice talent in another language. Dubbing, however, (despite isometric temporal match in translation) still leads to videos where the phonetics of the speech in the translated text does not match the actual lip-movement of the original speaker, when it replaces the voice of the original speaker by the voice of a speaker of the other language (usually, the voice talent). Despite considerable creativity, acting, art and effort go into creating a comparable experience by dubbing, the mismatch of lip-movement, the mismatch in speaker voice, and the mismatch in emphasis and prosody still create unnatural results in dubbed movies, teleconferences, lectures, newscasts, etc. The process is also costly and takes considerable effort and time in production, and thus cannot practically be applied to highly dynamic, frequently changing content, such as real-time events (e.g., videoconferencing, newscasts, etc.) or more low-cost, low-distribution content (lectures, speeches, interviews, etc.).

### SUMMARY

The present invention discloses, in one general aspect, how to overcome these short-comings by end-to-end lip-synchronous, voice and prosody preserving video-translation of speech, which process is variously referred to as “Face-Translation” or “Face-Dubbing.” For example, to overcome the problems of “dubbing,” the present invention is directed, in various embodiments, to a computer-based system and computer-implemented method that modifies the video of the input speech that preserves content, face, intent, style and voice characteristics of the original video, while translating the content to another language or format. Rather than adding a voice track from a second language and a second speaker to a video from a first language, embodiments of the present invention can translate and convert the video to the second language while preserving the original voice and content from the first language. In these tasks, for a given video of a speaker, a new video is generated (or synthesized), in which that speaker utters a translation of the original speech. Visual features of the speaker, such as the lips, etc., in the original video are matched to the translated audio and a multitude of audio characteristics are preserved in the new, synthesized video for the results to be convincing. While there exist approaches to solve parts of this task like lip-syncing and voice conversion, there is no end-to-end system that solves the problem of speech-translated, lip-synchronized, voice preserving video generation.

In one general aspect, therefore, the present invention is directed to an end-to-end speech translation system with voice conversion and lip synchronization that takes videos of a subject(s) speaking in a first language, e.g., English, and infers videos of the speaker(s) with translated audio in a second, different language, such as German, and accordingly adapted lip movements while preserving the voice characteristics and prosodic emphases of the original audio, including the voice characteristics and speaking style of the original speaker.

According to various embodiments, the present invention is directed to a system for generating output audio of an output speaker speaking in a target language from input audio of a first speaker speaking in a first language, where the first language is different from the target language. The system comprises an audio processing sub-system that comprises: one or more audio-processing machine learning module that are trained through machine learning to generate speech in the target language from speech, in the input audio, in the first language by the first speaker; and a voice conversion module trained, through machine learning, to generate adapted speech in the target language by adapting the speech in the target language from the one or more audio-processing machine learning models to voice characteristics of the first speaker in the input audio.

In another general aspect, the present invention is directed to system for generating an output video of an output speaker from input video of a first speaker, where the first speaker is speaking in a first language in the input video. The system comprises an audio processing sub-system, where the audio processing sub-system comprises a voice conversion module trained, through machine learning, to generated adapted speech in the first language by adapting the speech in the first language in the input video to voice characteristics of the first speaker in the input video. The system also comprises a video processing sub-system that comprises: a face detection module to detect a face of the first speaker in the input video; a lip generation module trained, through machine learning, to generate, based on the face of the first speaker in the input video from the face detection module and from the adapted speech from the voice conversion module, new video frames of face and lips of the output speaker that are synchronized to the adapted speech from the voice conversion module; and a video generation module that is configured to combine the new video frames from the lip generation module and the adapted speech from the voice conversion module to generate the output video such that movement of the lips of the output speaker in the output video is synchronized to the adapted speech from the voice conversion module.

In another general aspect, the present invention is directed to a system for generating an output video of an output speaker speaking in a target language. The system comprises a remote source for capturing input audio by the output speaker in a first language that is different from the target language and converting speech by the output speaker in the input audio into text in the first language. The system also comprises an audio processing sub-system and a video processing sub-system. The audio processing sub-system in communication with the remote source. The audio processing sub-system comprises one or more audio-processing machine learning modules trained through machine learning to generate speech in the target language based on the text in the first language from the remote source, of the speech by the output speaker in a first language that is different from the target language, where the audio processing sub-system is configured to receive the text of the speech by the output speaker in the first language from the remote source. The video processing sub-system stores pre-loaded video of the output speaker speaking. The video processing sub-system comprises: a face detection module trained, through machine learning, to detect a face of the output speaker in the pre-loaded video; a lip generation module trained, through machine learning, to generate, based on the face of the output speaker in the pre-loaded video from the face detection module and from the speech in the target language from the one or more audio-processing machine learning modules, new video frames of face and lips of the output speaker that are synchronized to the speech from the one or more audio-processing machine learning modules; and a video generation module that is configured to combine the new video frames from the lip generation module and the speech from the one or more audio-processing machine learning modules to generate the output video.

In another general aspect, the present invention is directed to a method that comprises generating, by one or more audio-processing machine learning modules of a computer system that is trained through machine learning, speech in a target language from input audio of speech by a first speaker in a first language. The method also comprises generating, by a voice conversion module of the computer system, which is trained through machine learning, adapted speech in the target language by adapting the speech in the target language from the one or more audio-processing machine learning modules. Generating the adapted speech comprises adapting the speech in to target language to voice characteristics of the first speaker in the input audio.

In another general aspect, the present invention is directed to a method that comprises generating, by a voice conversion module of a computer system, where the voice conversion module is trained through machine learning, adapted speech in a first language by adapting a speech in the first language in an input video to voice characteristics of a first speaker in the input video. The method also comprises the step of detecting, by a face detection module of the computer system, a face of the first speaker in the input video. The method also comprises the step of generating, by a lip generation module of the computer system, that is trained through machine learning, based on the face of the first speaker in the input video from the face detection module and from the adapted speech from the voice conversion module, new video frames of face and lips of an output speaker that are synchronized to the adapted speech from the voice conversion module. The method also comprises the step of combining, by a video generation module of the computer system, the new video frames from the lip generation module and the adapted speech from the voice conversion module to generate an output video such that movement of the lips of an output speaker in the output video is synchronized to the adapted speech from the voice conversion module.

In another general aspect, the present invention is directed to a method that comprises capturing, by a remote source, input audio by an output speaker in a first language that is different from a target language; converting, by the remote source, speech by the output speaker in the input audio into text in the first language; receiving, via a data network, by a computer system, from the remote source, the text in the first language; storing, in a memory of the computer system, pre-loaded video of an output speaker speaking; generating, by a translation module, trained through machine learning, of the computer system, a textual translation into the target language from the text in the first language from the remote source; generating, by a text-to-speech module, trained through machine learning, of the computer system, speech in the target language from the textual translation into the target language; detecting, by a face detection module of the computer system, a face of the output speaker in the pre-loaded video; generating, by a lip generation module, trained through machine learning, of the computer system, based on the face of the output speaker in the pre-loaded video from the face detection module and from the speech in the target language from the text-to-speech module, new video frames of the face and lips of the output speaker that are synchronized to the speech from the text-to-speech module; and combining, by a video generation module of the computer system, the new video frames from the lip generation module and the speech from the text-to-speech module to generate the output video.

In another general aspect, the present invention is directed to a computer system that comprises: one or more processor cores; and a memory in communication with the one or more processor cores. The memory stores instructions that when executed by the one or more processor cores, cause the one or more processor cores to: train, through machine learning, one or more audio-processing machine learning modules to generate speech in a target language from speech, in input training audio, by a training speaker in a first language; and train, through machine learning, a voice conversion module to generate adapted speech in the target language by adapting the speech in the target language to voice characteristics of the training speaker in the input training audio.

In another general embodiment, the memory stores instructions that when executed by the one or more processor cores, cause the one or more processor cores to: train, through machine learning, a voice conversion module of a computer system, to generate adapted speech in a first language by adapting a speech in the first language in an input video to voice characteristics of a training speaker in a training input video train, through machine learning, a lip generation module, to generate, based on a detected face of the training speaker in the training input video, and from the adapted speech from the voice conversion module, new video frames of face and lips of a training output speaker that are synchronized to the adapted speech from the voice conversion module; and after training the voice conversion module and the lip generation module to suitable levels of performance, in a deployment mode: (i) generating, by the voice conversion module, deployment-mode adapted speech in the first language by adapting a speech in the first language in a deployment-mode input video to voice characteristics of a first deployment-mode speaker in a deployment-mode input video; (ii) detecting, by a face detection module, a face of the first deployment-mode speaker in the deployment-mode input video; (iii) generating, by the lip generation module, based on the face of the first deployment-mode speaker in the deployment-mode input video from the face detection module and from the deployment-mode adapted speech from the voice conversion module, new, deployment-mode video frames of face and lips of a deployment-mode output speaker that are synchronized to the deployment-mode adapted speech from the voice conversion module; and (iv) combining, by a video generation module, the new, deployment-mode video frames from the lip generation module and the deployment-mode adapted speech from the voice conversion module to generate a deployment-mode output video such that movement of the lips of the deployment-mode output speaker in the deployment-mode output video is synchronized to the deployment-mode adapted speech from the voice conversion module.

In another general aspect, the present invention is directed to system a remote source and a computer system in communication with the remote source via a data network. The remote source for: capturing input audio by an output speaker in a first language that is different from a target language; and converting speech by the output speaker in the input audio into text in the first language. The computer system comprises: one or more processor cores; and a memory in communication with the one or more processor cores. The memory stores pre-loaded video of the output speaker speaking. The memory also stores instructions that when executed by the one or more processor cores, cause the one or more processor cores to: generate a textual translation into a target language from the text in the first language from the remote source; generate speech in the target language from the textual translation into the target language; detect a face of the output speaker in the pre-loaded video of the output speaker; generate, based on the face of the output speaker in the pre-loaded video and from the speech in the target language, new video frames of the face and lips of the output speaker that are synchronized to the speech in the target language; and combine the new video frames and the speech in the target language to generate an output video of the output speaker speaking in the target language.

These and other embodiments of the present invention, and benefits provided thereby, will be apparent from the description that follows.

### FIGURES

Various embodiments of the present invention are described herein by way of example in conjunction with the following figures.

FIGS. 1, 14, 15 and 16 are diagrams of a multimodal, end-to-end speech translation and lip-synching video generation system according to various embodiments of the present invention.

FIG. 2 is a diagram of a lip generation module of the video generation system of FIG. 1 according to various embodiments of the present invention.

FIG. 3 shows sample face images from an original video and in a generated, synthetic video. In the top row, eight consecutive frames from original video are presented. In the bottom row, the same eight frames with new lips are presented. The images in the bottom row are synthesized by using generated German speech in this illustrated example, which is the translation of the input speech in English.

FIGS. 4A-4C show subjective test results. Participants were asked to evaluate videos using embodiments of the present invention in several different aspects, namely the quality of the generated face images, the synchronization quality of the lips and speech, the accuracy of the translated speech, naturalness of the generated speech, and the intelligibility of the generated speech.

FIG. 5 illustrates a shot of a synthetic video with exaggerated, or enlarged, lip movement.

FIG. 6 illustrates a computer system according to various embodiments of the present invention.

FIG. 7 illustrates an overall structure of a Transformer-based model for the automatic speech recognition module of the multimodal system of FIG. 1 according to various embodiments of the present invention.

FIG. 8 illustrates a Conformer encoder model for the automatic speech recognition module of the multimodal system of FIG. 1 according to various embodiments of the present invention.

FIG. 9 illustrates a model architecture of a Transformer model for the machine translation module of the multimodal system of FIG. 1 according to various embodiments of the present invention.

FIGS. 10 and 11 illustrate a system or network including a video capture device, the video generation system of FIG. 1, and a video display device according to various embodiments of the present invention.

FIG. 12 illustrates a feed forward neural network.

FIG. 13 illustrates a voice generation system according to various embodiments of the present invention.

### DESCRIPTION

In the examples described below, it is assumed that the audio of the speaker is being translated from English (i.e., an input language) to German (i.e., a target language). The present invention is not so limited and can be used to translate speech by the speaker from another input language and to another target language, so long as there are suitable translation models.

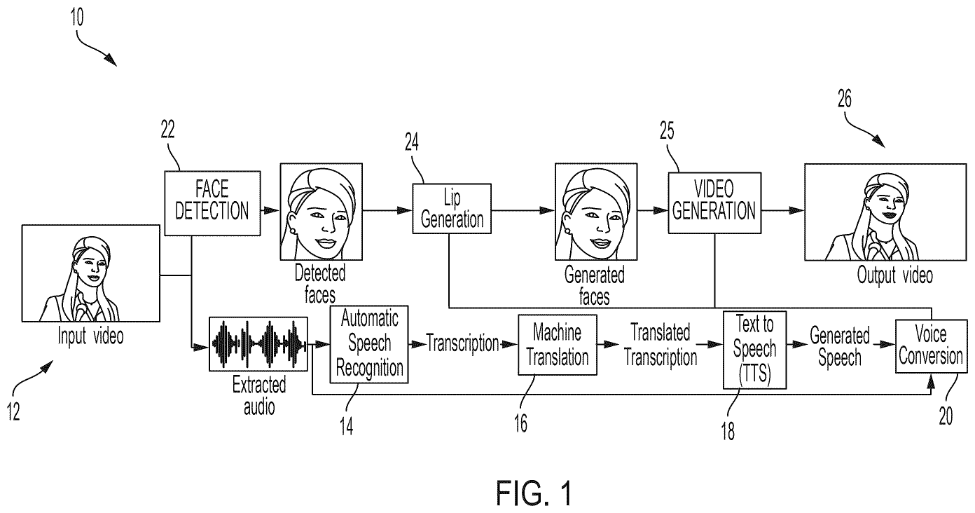

The multimodal system includes, according to various embodiments, two pipelines: a video pipeline (or video processing sub-system) for face detection and lip synchronization; and an audio pipeline (or audio processing sub-system) for speech recognition, translation, speech synthesis, and voice conversion. The desired output of the audio pipeline is, in various embodiments of the present invention, audio of the original speaker uttering a translation of the speech in the input video with properly aligned emphases if any are present in the original audio. This is achieved by pipelining multiple models. With reference to the multimodal system 10 shown in FIG. 1, first, from the original input video 12, the automatic speech recognition (ASR) model 14, preferably with emphasis detection, creates a transcript of the original speech in the first/original language (e.g., English) with additional emphasis information. Second, the English transcript is translated to German by the machine translation model 16 while any emphasis information is moved to the corresponding parts of the German translation. Third, a Text-to-Speech (TTS) model 18 synthesizes German speech (albeit not by the original speaker in the video 12) with appropriate emphases for the given translation and then, fourth, a voice conversion model 20 adapts the synthesized speech to the voice characteristics of the original speaker. Meanwhile, fifth (and not necessarily after step four), the vision pipeline includes a face detection module 22 that gets the input video frames 12 to detect the speaker's face in them. Sixth, a lip generation module 24 employs the generated speech (from fourth step) and detected faces (from fifth step) to synthesize new video frames of the speaker's face with lips that are synchronized to the generated speech. Finally, a video generation module 25 combines the video frames from the lip generation module 24 and the translated speech from the voice conversion module 20 to generate a final output video that shows the face of the speaker detected by the face detection module 22 speaking in the target language (e.g., German), with the face of the speaker in the output video 26 preferably preserving voice, prosody, and/or facial expressions from the speaker in the input video, and having the lip movements of the speaker in the output video 26 being synchronized to the translated speech in the target language. Comprehensive experiments were conducted to evaluate the performance of each module as well as the entire system 10. For the final end-to-end system, a user study was also conducted to assess diverse aspects of output quality like intelligibility and naturalness of speech, synchronicity of lips and audio, and credibility of the face in the video.

To the best of the inventor's knowledge, this is the first neural end-to-end system to perform isometric translation for videos of speakers from one language to another while considering accurate lip synchronization. The system creates realistic speech and video while preserving voice characteristics and emphases. In various embodiments, a modification to the FastSpeech 2 TTS model 18 is used to achieve fine-grained prosody control for the synthesized speech.

The sequence-to-sequence ASR model 14 can be trained to transcribe audio of the original (e.g., English) speech in the input video. Three architectures could be used and were evaluated: The long short-term memory (LSTM) based model, the Transformer, and the Conformer LSTM-based model. LSTM-based (see Thai-Son Nguyen, Sebastian Stueker, Jan Niehues, and Alex Waibel, “Improving sequence-to-sequence speech recognition training with on-the-fly data augmentation,” ICASSP 2020-2020 IEEE International Conference on Acoustics, Speech and Signal Processing (ICASSP), pages 7689-7693, “Nguyen et al., 2020a,” which is incorporated herein by reference in its entirety) models include, for example, 6 bidirectional layers for the encoder and 2 unidirectional layers for the decoder, with 1536 units in each. In a LSTM-based model, placed before the LSTM layers in the encoder is a two-layer Convolutional Neural Network (CNN) with 32 channels and a time stride of two to down-sample the input spectrogram by a factor of four. In the decoder, two layers of unidirectional LSTMs can be adopted as language modeling for the sequence of subword units and the approach of Scaled Dot-Product (SDP) Attention to generate context vectors from the hidden states of the two LSTM networks.

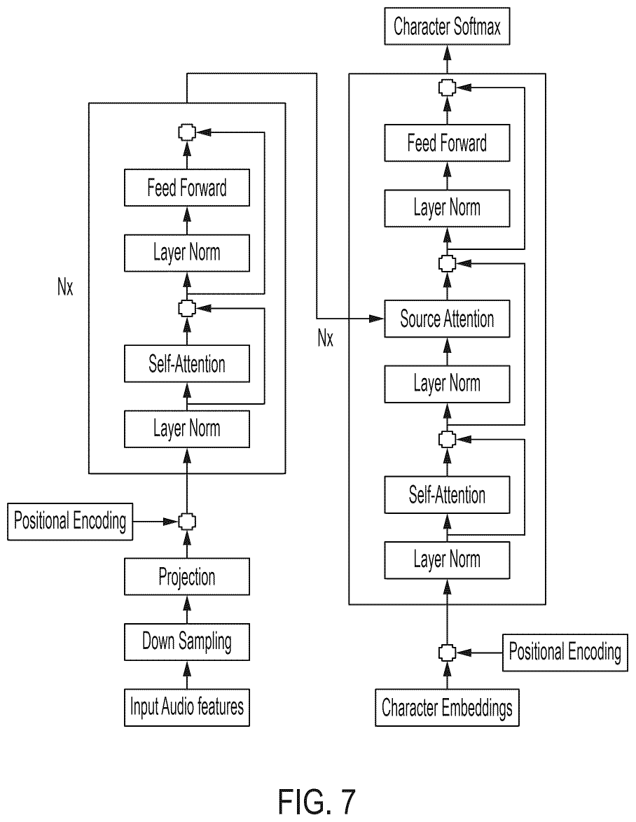

The Transformer-based models (see Ngoc-Quan Pham, Thai-Son Nguyen, Jan Niehues, Markus Muëller, Sebastian Stücker, and Alexander Waibel, 2019, “Very deep self-attention networks for end-to-end speech recognition,” arXiv preprint arXiv: 1904.13377, “Pham et al., 2019,” which is incorporated herein by reference in its entirety) can also be used. The Transformer architecture is based on self-attention and can capture long distance interactions and can have a high training efficiency. A Transformer model can feature, for example, in various embodiments, 24 encoder layers and 8 decoder layers. The overall structure of a Transformer-based model is shown in FIG. 7. The encoder and decoder of the Transformers are constructed by layers, each of which contains self-attentional sub-layers coupled with feed-forward neural networks. To adapt the encoder to long speech utterances, a reshaping practice may be used by grouping consecutive frames into one step. Subsequently, the input features can be combined with sinusoidal positional encoding. While directly adding acoustic features to the positional encoding is harmful, potentially leading to divergence during training, that problem can be resolved simply projecting the concatenated features to a higher dimension before adding (512, as other hidden layers in the model). In the case of speech recognition specifically, the positional encoding offers a clear advantage compared to learnable positional embeddings because the speech signals can be arbitrarily long with a higher variance compared to text sequences.

The Transformer encoder passes the input features to a self-attention layer followed by a feed-forward neural network with 1 hidden layer with the ReLU activation function. Before these sub-modules, residual connections can be included which establishes short-cuts between the lower-level representation and the higher layers. The presence of the residual layer massively increases the magnitude of the neuron values which is then alleviated by the layer-normalization layers placed after each residual connection. The decoder is the standard Transformer decoder in the recent translation systems. The notable difference between the decoder and the encoder is that to maintain the auto-regressive nature of the model, the self-attention layer of the decoder must be masked so that each state has only access to the past states. Moreover, an additional attention layer using the target hidden layer layers as queries and the encoder outputs as keys and values is placed between the self-attention and the feed-forward layers. Residual and layer-normalization are setup identically to the encoder.

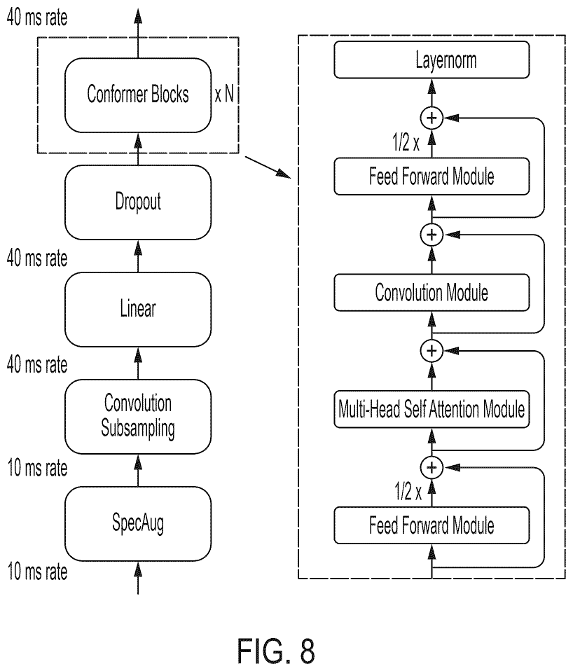

A Conformer-based model (see Anmol Gulati, James Qin, Chung-Cheng Chiu, Niki Parmar, Yu Zhang, Jiahui Yu, Wei Han, Shibo Wang, Zhengdong Zhang, Yonghui Wu, et al., 2020, “Conformer: Convolution-augmented transformer for speech recognition,” arXiv preprint arXiv: 2005.08100) is a convolution-augmented Transformer for speech recognition. In various embodiments, a Conformer-based model can comprise, for example, 16 encoder layers and 6 decoder layers. FIG. 8 shows an example Conformer encoder model architecture. It can comprise two macaron-like feed-forward layers with half-step residual connections sandwiching the multi-headed self-attention and convolution modules. This is followed by a post layernorm.

The size of each layer in both the Transformer-based and the Conformer-based models can be, for example, 512, while the size of the hidden state in the feed-forward sublayer is 2048, in various embodiments. As explained in (see Nguyen et al., 2020a), the speech data augmentation approach can be employed to reduce overfitting. Stochastic Layers with a dropout rate of, for example, 0.5 on both Transformer-based and Conformer-based models can be used to successfully train a deep network (see Pham et al., 2019). To classify an emphasis word, a binary classifier layer can be added to the network's top. The ensemble of LSTM-based and Conformer-based sequence-to-sequence model provided the best results.

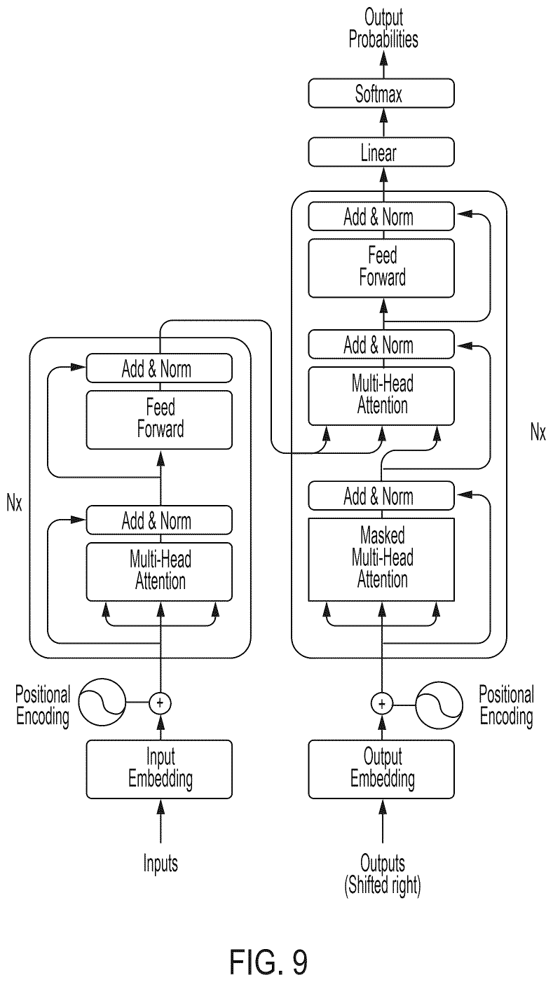

Translation from English to German by the machine translation module 16 can use a neural sequence-to-sequence model. More specifically a Transformer (see Ashish Vaswani, Noam Shazeer, Niki Parmar, Jakob Uszkoreit, Llion Jones, Aidan N. Gomez, Łukasz Kaiser, and Illia Polosukhin, 2017, “Attention is all you need,” Proceedings of the 31st International Conference on Neural Information Processing Systems, NIPS′17, page 6000-6010, Red Hook, NY, USA. Curran Associates Inc., “Vaswani et al., 2017,” which is incorporated herein by reference in its entirety) model can be employed with the base configuration as described by Vaswani et al. 2017, implemented in the NMT-GMinor framework (see Ngoc-Quan Pham, Thanh-Le Ha, Tuan-Nam Nguyen, Thai-Son Nguyen, Elizabeth Salesky, Sebastian Stücker, Jan Niehues, and Alex Waibel, “Relative Positional Encoding for Speech Recognition and Direct Translation,” Proc. Interspeech 2020, pages 31-35, which is incorporated herein by reference in its entirety). FIG. 9 shows a model architecture for such a Transformer model according to various embodiments. The encoder can be composed of a stack of N=6 identical layers. Each layer has two sub-layers. The first is a multi-head self-attention mechanism, and the second is a simple, position-wise fully connected feed-forward network. A residual connection can be employed around each of the two sub-layers, followed by layer normalization. That is, the output of each sub-layer is LayerNorm (x+Sublayer(x)), where Sublayer (x) is the function implemented by the sub-layer itself. To facilitate these residual connections, all sub-layers in the model, as well as the embedding layers, produce outputs of dimension dmodel=512.

The decoder can also be composed of a stack of N=6 identical layers. In addition to the two sub-layers in each encoder layer, the decoder inserts a third sub-layer, which performs multi-head-attention over the output of the encoder stack. Similar to the encoder, residual connections can be employed around each of the sub-layers, followed by layer normalization. The self-attention sub-layer in the decoder stack can be modified to prevent positions from attending to subsequent positions. This masking, combined with fact that the output embeddings are offset by one position, ensures that the predictions for position i can depend only on the known outputs at positions less than i.

The model could be trained, for example, on 1.8 million sentences of Europarl data (Philipp Koehn, 2005, “Europarl: A parallel corpus for statistical machine translation,” Proceedings of Machine Translation Summit X: Papers, pages 79-86, Phuket, Thailand) and finally fine tuned on 150,000 sentences of TED data (see Mauro Cettolo, Christian Girardi, and Marcello Federico, 2012, “Wit3: Web inventory of transcribed and translated talks,” Conference of European association for machine translation, pages 261-268) for better adaptation towards spoken language.

For emphasis translation, a source-to-target word alignment can be extracted. For each emphasized input token, the matching output token can be determined and put emphasis on this output token. The word alignment obtained by averaging the normalized attention scores from each head of the final encoder-decoder multihead-attention layer:

$${α}_{ji} = \frac{1}{h} {\sum }_{k = 0}^{h} {α}_{ji}^{k}$$

$${α}^{k} = soft max ( \frac{( {QW}_{k}^{Q} ) {( {KW}_{k}^{K} )}^{T}}{\sqrt{d}} )$$

where h=8 is the number of attention heads, d=512 is the model size, and Q, W, WK and WQ are as described in Vaswani et al. 2017. For each emphasized input token si emphasis is thus put on the output token tⱼ with j=argmax_{k=1 . . . |T|}(aₖᵢ).

A modified FastSpeech 2 (see Yi Ren, Chenxu Hu, Xu Tan, Tao Qin, Sheng Zhao, Zhou Zhao, and Tie-Yan Liu, 2020, “Fastspeech 2: Fast and high-quality end-to-end text to speech,” International Conference on Learning Representations, which is incorporated herein by reference in its entirety) model can be used by the TTS 18 for synthesizing mel spectrograms of speech for a given text. Other popular TTS models like Tacotron 2 (see Jonathan Shen, Ruoming Pang, Ron J Weiss, Mike Schuster, Navdeep Jaitly, Zongheng Yang, Zhifeng Chen, Yu Zhang, Yuxuan Wang, R J Skerrv-Ryan, et al, 2018, “Natural tts synthesis by conditioning wavenet on mel spectrogram predictions,” 2018 IEEE International Conference on Acoustics, Speech and Signal Processing (ICASSP), pages 4779-4783, which is incorporated herein by reference in its entirety.) could be used, but FastSpeech 2 allows for faster inference times due to its non-autoregressive nature. The FastSpeech2 architecture is based on the encoder-decoder architecture and employs multiple feed-forward Transformer blocks (see Yi Ren, Yangjun Ruan, Xu Tan, Tao Qin, Sheng Zhao, Zhou Zhao, and Tie-Yan Liu, 2019, “Fastspeech: Fast, robust and controllable text to speech,” Advances in Neural Information Processing Systems, 32, which is incorporated herein by reference in its entirety) that are made up of stacks of self-attention and 1-DD convolution layers.

To make non-autoregressive TTS feasible, the Fast-Speech 2 model can employ variance adaptors, e.g., three variance adaptors, which provide information on prosody to ease the one-to-many mapping problem inherent to TTS. The three variance adaptors can enrich the hidden sequence by adding predicted pitch, duration, and energy information on phoneme-level to the hidden sequence, thereby helping the decoder by easing the one-to-many mapping problem of TTS. To further ease the training process of the model and make phoneme-level variance prediction possible, the model can be given the input text not as a sequence of graphemes but rather as a sequence of phonemes. Consequently, prior conversion is needed for grapheme inputs. This can be done, for example, by consulting a pronunciation dictionary and, for words not present in the dictionary, by employing a grapheme to phoneme model trained using the Montreal Forced Aligner (see Michael McAuliffe, Michaela Socolof, Sarah Mihuc, Michael Wagner, and Morgan Sonderegger, 2017, “Montreal forced aligner: Trainable text-speech alignment using kaldi,” Interspeech, volume 2017, pages 498-502, which is incorporated herein by reference in its entirety). A Montreal Forced Aligner (MFA) can use triphone acoustic models to capture contextual variability in phone realization. A MFA can also include speaker adaptation of acoustic features to model interspeaker differences. A MFA can use the Kaldi speech recognition toolkit. The ASR pipeline that MFA implements can use a standard GMM/HMM architecture, adapted from existing Kaldi recipes. To train a model, monophone GMMs are first iteratively trained and used to generate a basic alignment. Triphone GMMs are then trained to take surrounding phonetic context into account, along with clustering of triphones to combat sparsity. The triphone models are used to generate alignments, which are then used for learning acoustic feature transforms on a per-speaker basis, in order to make the models more applicable to speakers in other datasets.

Originally, the predictions of the variance adaptors can only be controlled for the entire utterance. The possibility to add information input is added by supporting Speech Synthesis Markup Language (see Paul Taylor and Amy Isard, 1997, “Ssml: A speech synthesis markup language,” Speech communication, 21 (1-2): 123-133, which is incorporated herein by reference in its entirety) (SSML) tags regarding the controllable aspects of prosody in the input text. Using SSML, emphasis tags can be added to words in the translation that correspond to words in the original transcript that were emphasized by the speaker. The system will then, in various embodiments, adapt the prosodic control values for the phonemes of that word to create an emphasis in the output. This is done by increasing duration and energy for that word as well as increasing or decreasing pitch depending on the originally predicted pitch for the word. Finally, a HiFi-GAN vocoder (see Jungil Kong, Jaehyeon Kim, and Jaekyoung Bae, 2020, “Hifi-gan: Generative adversarial networks for efficient and high fidelity speech synthesis,” Advances in Neural Information Processing Systems, 33, which is incorporated herein by reference in its entirety) can be used to infer audio waveforms from the Mel spectrograms generated by the TTS model. A HiFi-GAN can comprise one generator and two discriminators: multi-scale and multi-period discriminators. The generator and discriminators are trained adversarially, along with two additional losses for improving training stability and model performance.

For voice conversion 20, VQMIVC (Vector quantization mutual information voice conversion) can be used, which uses a straightforward autoencoder architecture to solve the voice conversion issue. The framework consists of four modules: a content encoder that produces a content embedding from speech, a speaker encoder that produces a speaker embedding (D-vector) from speech, a pitch encoder that produces prosody embedding from speech, and a decoder that generates from content, prosody, and speaker embeddings. The phonetic, prosody is represented through content embedding and prosody embedding. The content embedding is discretized by the vector quantization module and used as target for the contrastive predictive coding loss.

The mutual information (MI) loss measures the dependencies between all representations and can be effectively integrated into the training process to achieve speech representation disentanglement. During the conversion stage, the source speech is put into the content encoder and pitch encoder to extract content embedding and prosody embedding. To extract target speaker embedding, the target speech is sent into the speaker encoder. Finally, the decoder reconstructs the converted speech using the source speech's content embedding and prosody embedding and the target speech's speaker embedding. A pre-trained VQMIVC voice conversion can be adapted on both German and English datasets to get better performance on both languages. The VQMIVC model can be fine-tuned with the appropriate hyperparameters. The evaluation of VQMIVC is described in (see Disong Wang, Liqun Deng, Yu Ting Yeung, Xiao Chen, Xunying Liu, and Helen Meng, 2021, “Vqmivc: Vector quantization and mutual information-based unsupervised speech representation disentanglement for one-shot voice conversion,” which is incorporated herein by reference in its entirety).

The lip generation task can be addressed as a conditional generative adversarial network-based (see Ian Goodfellow, Jean Pouget-Abadie, Mehdi Mirza, Bing Xu, David Warde-Farley, Sherjil Ozair, Aaron Courville, and Yoshua Bengio, 2014, “Generative adversarial nets,” Advances in neural information processing systems, 27; Mehdi Mirza and Simon Osindero, 2014, “Conditional generative adversarial nets,” arXiv preprint arXiv: 1411.1784, which is incorporated herein by reference in its entirety) image generation. The lip generation module 24 can be implemented based on KR Prajwal, Rudrabha Mukhopadhyay, Vinay P Namboodiri, and CV Jawahar, 2020b, “A lip sync expert is all you need for speech to lip generation in the wild,” Proceedings of the 28th ACM International Conference on Multimedia, pages 484-492, “Prajwal et al., 2020b,” which is incorporated herein by reference in its entirety. An audio-guided face generator G can be used to synthesize a face image that is synchronized with the audio. The generator G can comprise three blocks: (i) Identity Encoder, (ii) Speech Encoder, and a (iii) Face Decoder. The Identity Encoder is a stack of residual convolutional layers that encode a random reference frame R, concatenated with a pose-prior P (target-face with lower-half masked) along the channel axis. The Speech Encoder is also a stack of 2D-convolutions to encode the input speech segment S which is then concatenated with the face representation. The decoder is also a stack of convolutional layers, along with transpose convolutions for upsampling. The generator is trained to minimize L1 reconstruction loss between the generated frames and ground-truth frames.

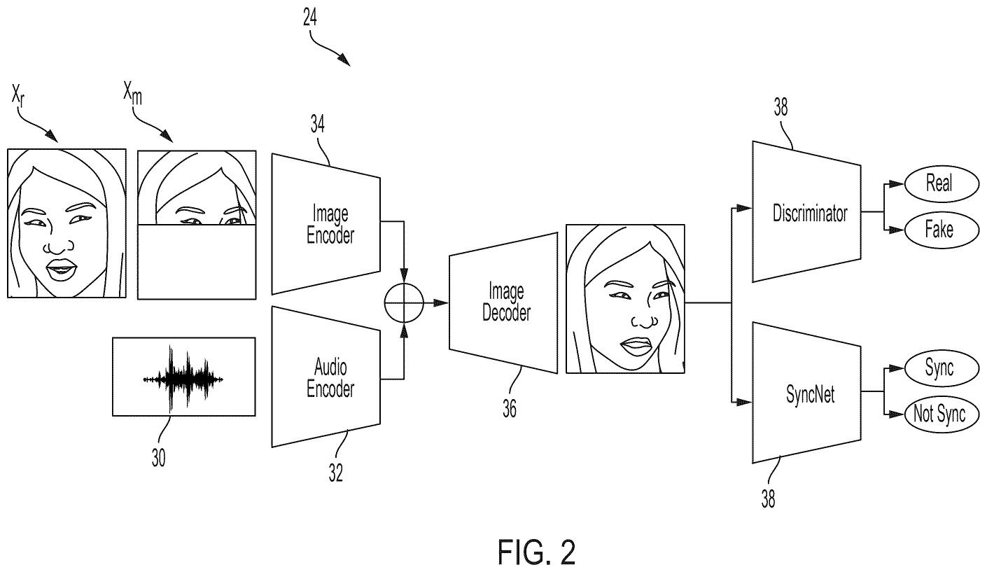

For this, with reference to FIG. 2, an audio sequence 30 can be provided to the audio encoder 32 as an input to acquire an embedded feature representation of it. Moreover, an image encoder 34 can be utilized to encode the input image. The input image can have six channels, namely the depth-wise concatenation of two separate images. While the first three channels contain a face of the corresponding ground truth subject from another time sequence, namely reference image xᵣ, the second image is the masked version of the ground truth face, xₘ. The task is to generate the masked area of xₘ with respect to the audio sequence. Besides, reference image xᵣ is useful to inject identity information to the G. Otherwise, it would be challenging for the generator to preserve the identity. Audio and image features can be concatenated along the depth to feed the face decoder 36.

Residual connections between the reciprocal layers of the image encoder and image decoder networks can be used in the generator G. These connections allow the output of encoder's layers to be transmitted to the decoder's layers in order to transfer the crucial details and identity of the input face images. The ReLU activation function can be used in the generator with instance normalization layers.

For the discriminator 38, a binary classifier with a cross-entropy loss can be employed to distinguish real and fake images. This discriminator is responsible for the quality and realism of the generated image. However, it preferably must also controlled whether the prior condition is provided in the generated image as it is proposed in Prajwal et al., 2020b. For this, a pre-trained synchronization model 40 (see Joon Son Chung and Andrew Zisserman, 2016, “Out of time: automated lip sync in the wild,” Asian conference on computer vision, pages 251-263. Springer; Prajwal et al., 2020b, which is incorporated herein by reference) can be employed to evaluate the coherence between the conditional input audio and the output face image. The whole lip generation system is illustrated in FIG. 2.

To train the system, a large-scale Oxford-BBC Lip Reading Sentence 2 dataset (LRS2) (see T. Afouras, J. S. Chung, A. Senior, O. Vinyals, and A. Zisserman, 2018, “Deep audio-visual speech recognition,” arXiv: 1809.02108; J. S. Chung, A. Senior, O. Vinyals, and A. Zisserman, 2017, “Lip reading sentences in the wild,” IEEE Conference on Computer Vision and Pattern Recognition; J. S. Chung and A. Zisserman, 2017, “Lip reading in profile,” British Machine Vision Conference, which are incorporated herein by reference in their entireties) can be used. The image generator can be fed with a set of sequence frames. The audio data can be send to audio encoder after a mel-spectrogram representation is obtained of the corresponding audio sequence. During the experiments, the proposed data splits to train, validate, and test the model were followed. In order to calculate synchronization loss, the pre-trained lip synchronization model (Prajwal et al., 2020b) can be directly used, without this model being updated during the training. The overall loss function can be as follows:

$$L = {L}_{cGAN} + α * {L}_{img} + β * {L}_{sync}$$

where L_{cGAN} is a conditional adversarial loss, Limg is an image reconstruction loss, ∥y−y′∥, that calculates the L1 distance between target face image and the generated face image in the pixel space. Lsync is a synchronization loss that provides feedback to the generator whether the synchronization between the lip and the audio input is able to be provided in the generated face image. Coefficients α and β alter the effect of image reconstruction loss and synchronization loss on the total loss. According to the experimental results, the best results might be α and β coefficients as 1 and 0.05, respectively.

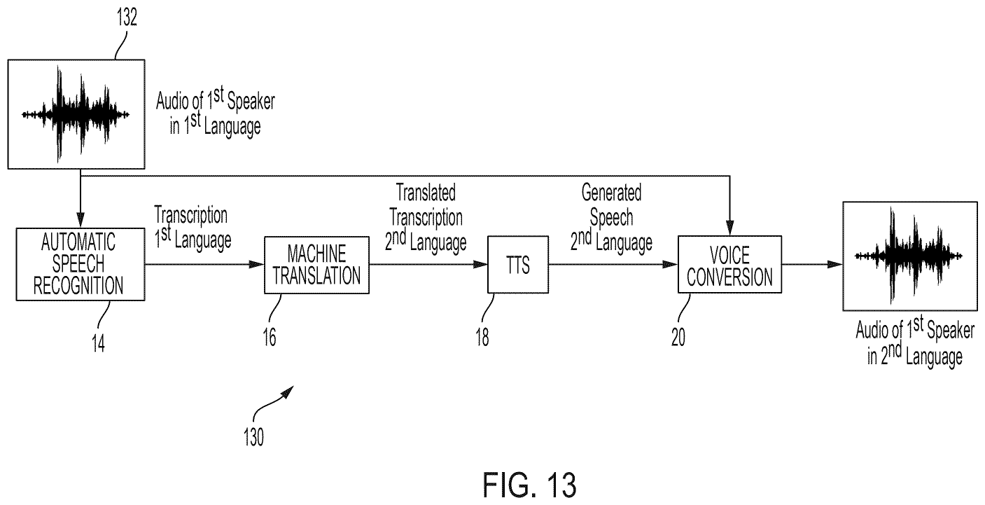

The lip generation module 24 preferably synchronizes as closely as possible the lip movements of the speaker in the video frames generated by the lip generation module 24 (and ultimately in the output video 26) to adapted speech from the voice conversion module 20. The lip generation module 24 can also be trained to preserve facial expressions of the speaker in the input video 12 in the output video 26. Note that the speakers in the input and output videos could be the same or different. For example, the output speaker could be an animated character. Regardless of whether the input and output speakers are the same, the facial expressions, voice characteristics, and/or prosodic characteristics of the speaker in the input video 12 can be preserved in the output video 26. The types of facial expressions that the lip generation module 24 could be trained to preserve include frowns, smiles, coughs, sneezes, twitching, blinking, etc. The voice conversion module 20 can be trained to preserve the voice and prosodic characteristics of the input speaker. As shown in FIG. 1 (and FIG. 13 described further below), the voice conversion module 20 can also receive the audio input to preserve the voice and/or prosodic characteristics of the input speaker.

To combine the multitude of models for ASR, translation, TTS, voice conversion, and Lip Generation into a single system, a cascade architecture can be used. A diagram of the high-level architecture of the video generation system is shown in FIG. 1. The following provides an outline of the workings of the system given a single video of an English speaker as input.

Initially, the audio (in English) of the given video is extracted and converted to the expected waveform format of the ASR module 14, which then creates an English transcription of the input speech with additional information regarding detected emphases. The translation module 16 now produces a German translation of that transcript, including SSML tags for emphases at the parts of the text that correspond to words in the original English transcript that were marked as emphasized by the ASR module 14. Subsequently, the TTS module 18 is given this translated text and the resulting Mel spectrogram is turned into a waveform file by the HiFi-GAN vocoder. The final audio is now created by the voice conversion module 20, which gets the waveform of German speech that the vocoder produced as input and uses the original English audio of the input video as target speaker. The video pipeline (or sub-system) starts by detecting, by the face detection module 22, faces in the input video. The lip generation module 24 is given the detected faces in every frame of the input video as well as the speech produced by the voice conversion module and generates new video frames of the speaker's face with the lips of the speaker adapted to the given German audio. As such, the lip generation module is not invoked until voice conversion module creates the final audio. Finally, a video generation system 25 combines the video frames from the lip generation module 24 and the German speech from the voice conversion module 20 to create the final output video 26. The whole pipeline allows a video to be acquired with translated speech of the original speaker in the target language and the adapted lips by only providing an arbitrary video.

For training and evaluation of the ASR models, the Mozilla Common Voice v6.1, Europarl, How2, Librispeech, MuST-C v1, MuST-C v2 and Tedlium v3 datasets can be used. The text parallel training data provided by WMT 2019, 2020, 2021 can also be used for training MT consisting of a total of 69.8 million sentences as shown on the right side of Table 1.

TABLE 1
Summary of the English data-sets used for speech recognition
(left) and machine translation (right)

| | | |
|---|---|---|
| Corpus | Utterances | Speech data [h] |

A: Training Data

| | | |
|---|---|---|
| Mozilla Common Voice | 1225k | 1667 |
| Europarl | 33k | 85 |
| How2 | 217k | 356 |
| Librispeech | 281k | 963 |
| MuST-C v1 | 230k | 407 |
| MuST-C v2 | 251k | 482 |
| Tedlium | 268k | 482 |

B: Test Data

| | | |
|---|---|---|
| Tedlium | 1155 | 2.6 |
| Librispeech | 2620 | 5.4 |

| Dataset | Sentences |
|---|---|
| TED Talks (TED) | 220K |
| Europarl (EPPS) | 2.2MK |
| CommonCrawl | 2.1M |
| Rapid | 1.21M |
| ParaCrawl | 25.1M |
| OpenSubtitles | 12.6M |
| WikiTitle | 423K |
| Back-translated News | 26M |

CSS10 is a collection of single speaker speech datasets that contain ten different languages. It includes short audio clips and their aligned text data. Since the aim was to generate the audio in German, the CSS10 German dataset was used to train the TTS model as it provides 17 hours of high-quality single speaker audio data which is enough to train a single speaker TTS model. The Oxford-BBC Lip Reading Sentences 2 (LRS2) dataset can be used to train the lip generation model and also evaluate its performance. Train, validation, and test setups can be followed to train the model as well as evaluate the performance. The training set contained 45839 utterances, while the validation and test sets included 1082 and 1243 utterances respectively. Since there is no suitable dataset to test the end-to-end video translation system in the literature, the evaluation can use various videos collected from the internet to create a test set. The test set could contain, for example, 262 different video clips belonging to 25 different speakers. The duration of the test clips can be about ten seconds. If the system is designed to produce German output from English input, the speakers for the evaluation preferable speak English.

The word error rate (WER) is a common metric for measuring speech recognition performance. The Levenshtein distance at the word level can be used to calculate the WER. The WER of Librispeech test set represents the ASR's performance on read speech, while the WER of Tedlium test set represents the ASR's performance on spontaneous speech. The BLEU, or Bilingual Evaluation Understudy, is a score that compares a candidate translation of text against one or more reference translations.

Since the FID, SSIM, and PSNR are not able to evaluate the synchronization of the lips and the synchronization is a crucial key-point in the lip generation task in addition to the quality of the generated face images, using Lip-Sync Error-Distance (LSE-D) and Lip-Sync Error-Confidence (LSE-C) provides a more reliable representation about the synchronization. Therefore, the LSE-D and LSE-C metrics could be used to evaluate the synchronization performance of the lip generation model. In order to evaluate the quality of the generated face images, the FID score was used by providing the manipulated face images. Thus, FID basically calculates the distance between real samples and generated samples in the feature space. For this, Inceptionv3 image classification model, which was trained on ImageNet dataset, can be utilized to extract features. In this metric, a lower score indicates better quality for the generated images. For the evaluation of the TTS model as well as the whole system there are no widely accepted computable quality metrics. So in order to evaluate the TTS model and the whole system, user studies can be conducted and where participants are asked to evaluate the performance in several different aspects.

The ASR and translation models can be evaluated by employing computable metrics on standard datasets. For ASR, the ensemble of LSTM-based and Conformer-based sequence-to-sequence model achieves WERs of respectively 2.4 and 3.9 on the Libri and Tedlium test sets. In Table 2, the results of Conformer-based, Transformer-based, LSTM-based, and ensemble-based approaches are presented. According to the table, ensemble-based method achieves the best results on Libri test, while it reaches the same performance with LSTM-based approach and surpasses the Conformer-based and Transformer-based methods on TED-LIUM test set. Therefore, the ensemble-based approach was used in the final system for one embodiment. Also, the translation model attained a translation score of 29.7 BLEU on the IWSLT tst2010 test set.

TABLE 2
WER results on Libri and Tedlium test sets. While the best
results were obtained with the ensemble-based method on the
Libri dataset, the best results were obtained with ensemble-
based and LSTM-based methods on the Tedium dataset.

| Data | Libri | Tedlium |
|---|---|---|
| Conformer-based | 3.0 | 4.8 |
| Transformer-based | 3.2 | 4.9 |
| LSTM-based | 2.6 | 3.9 |
| Ensemble | 2.4 | 3.9 |

The TTS model can be trained on the CSS10 German dataset, which is a single-speaker dataset consisting of nearly 17 hours of German speech and on the LJSpeech dataset, an English single-speaker dataset consisting of approximately 24 hours of speech. A Montreal Forced Aligner can be used to transform the grapheme inputs of the datasets to phoneme sequences and generate the text-audio alignments needed for training the variance adaptors. Training can be performed on a server with an Intel 4124 CPU, 32 gigabytes of memory, and a single NVIDIA RTX Titan GPU and, in one experiment, took approximately 72 hours. A pre-trained universal HiFi-GAN model can be used as vocoder, with no fine-tuning was necessary.

The evaluation of the TTS system was performed, in one experiment, in two user studies. A first study was conducted to compare the performance of a modified FastSpeech 2 architecture on the LJSpeech dataset with the widely used Tacotron 2 architecture to get a baseline. A second user study was done on the model, which was trained on the German CSS10 dataset in order to evaluate its performance when applying fine-grained prosody control. For comparison with Tacotron 2, ten texts were synthesized from the test set of the LJSpeech dataset with both Tacotron 2 and FastSpeech 2. For ground truth comparison, the respective audio samples were used. A group of eight participants was then asked to rate the quality of the audio samples on a scale from 1 to 5. After that, mean opinion scores (MOS) and confidence intervals were calculated. Table 3 shows the MOS and confidence intervals results from this survey. As the results show, the modified FastSpeech 2 model performed as well as Tacotron 2. This suggests that the modifications to FastSpeech 2 did not decrease the quality of the synthesized speech.

For subjective evaluation of the German TTS system and the fine-grained prosody control capabilities of the model, speech could be synthesized for texts randomly drawn from the test set of the CSS10 dataset. For ground truth comparison, random audio samples could be chosen from the test set. The quality of the generated speech could be compared when using default prosody with the quality of generated speech with added emphases. This additional comparison could be conducted only on the German model as this is the model used in the final system evaluation, according to various embodiments. To evaluate the capability of the system to add emphases to the synthesized speech, the chosen text samples could be synthesized again, this time with an emphasis added to a random word. To get a more differentiated view on quality differences between unemphasized and emphasized TTS outputs, the group of eight participants asked to rate the audio quality considering two metrics, naturalness and intelligibility on a scale from 1 to 5. For the emphasized TTS outputs perceptibility of emphasis was additionally rated by the participants. Table 4 shows the MOS and confidence intervals for ground truth and unemphasized samples. Table 5 shows the MOS and confidence intervals for the synthesized samples with added random emphasis. Additionally, changes in naturalness and intelligibility scores when compared with non-emphasized TTS samples are shown.

TABLE 4
MOS and 95% confidence intervals
for ground truth and TTS samples.

| | Naturalness | Intelligibility |
|---|---|---|
| Ground Truth | 4.28 ± 0.12 | 4.82 ± 0.08 |
| Synthesis | 3.59 ± 0.28 | 4.69 ± 0.09 |

TABLE 5
MOS, Comparison, and 95% confidence intervals regarding
naturalness, intelligibility and perceptibility of emphasis
for TTS samples with randomly emphasized word

| | TTS with | Change vs. |
|---|---|---|
| | Emphasis | Standard Synthesis |
| Naturalness | 3.29 ± 0.16 | −0.3 |
| Intelligibility | 4.71 ± 0.13 | +0.02 |
| Emphasis | 3.75 ± 0.28 | — |

The results show no clear difference between intelligibility scores of synthesized samples and ground truth samples. However, naturalness is rated worse for synthesized samples, implying a perceptible difference in audio quality or prosody when comparing ground truth and synthesized samples. But these differences do not seem to decrease intelligibility in any way. Adding emphases to the generated speech seems to slightly decrease naturalness, suggesting that the emphases, while being well perceptible, might not sound entirely natural. The overall performance of the model, even when emphases are added, is comparable with the MOS results for Tacotron 2 and our modified FastSpeech 2 obtained in the first user study (Table 3). However, there cannot be any conclusive comparison as these models have been trained for English speech and only a single MOS value was given by the participants.

In order to evaluate the lip generation performance, three different strategies were followed in one embodiment. First is evaluation of the quality of the generated images by using FID score. The conditional image generation was considered by measuring the synchronization between the generated lip and the audio input. For this, benefit was obtained from recently proposed novel metrics, LSE-D and LSE-C, which are basically distance and confidence scores for the synchronization performance. Finally, subjective tests were performed to quantify the proposed system's performance. Table 6 shows the LSE-D, LSE-C, and FID scores for LRS2 test set as well as the proposed test set. The LSE-D and LSE-C results on LRS2 dataset show that the model and Wav2Lip achieve almost the same performance to provide synchronized lips, although Wav2Lip shows slightly better scores. On the other hand, on the proposed dataset, slightly better scores were achieved in English case and in German case, though the scores are quite similar. This outcome indicates that both models have an effective generalization capacity and they are robust against real-world challenges, since both models show a well performance on unseen dataset. Moreover, the FID scores are again very close to each other. However, Wav2Lip achieves better FID scores on LRS2 and the proposed dataset. This FID analysis indicates that the generation quality of our model should be improved. Please note that the FID score could not be calculated for the proposed dataset, since the faces were generated based on the German audio input; therefore, there are no ground truth images.

TABLE 6
Evaluation of Wav2Lip and our model

| Model | Data | Language | LSE-D | LSE-C | FID |
|---|---|---|---|---|---|
| Wav2Lip-GAN | LRS2 | English | 6.46 | 7.78 | 4.44 |
| Ours | LRS2 | English | 6.98 | 6.93 | 8.86 |
| Wav2Lip-GAN | Ours | English | 8.35 | 6.40 | 19.62 |
| Ours | Ours | English | 8.11 | 6.52 | 21.15 |
| Wav2Lip-GAN | Ours | German | 7.93 | 7.18 | — |
| Ours | Ours | German | 7.90 | 7.17 | — |

In order to evaluate the whole system, a user study was conducted with 25 participants. In this way, the aim was to investigate the performance of the system by considering several different aspects: 1) realism of the generated face, 2) naturalness of the generated voice, 3) intelligibility of the speech, 4) synchronization quality of the speech and lip, 5) accuracy of the translated speech given the original English transcript. One question was asked for each aspect. However, only the participants who know the German language answered the questions related to intelligibility and the German translation of the speech. In the user study, 80 videos were randomly chosen from the 262 videos of the dataset described above and show the translated and lip-synced results to the participants with the transcribed original speech as well as the five questions.

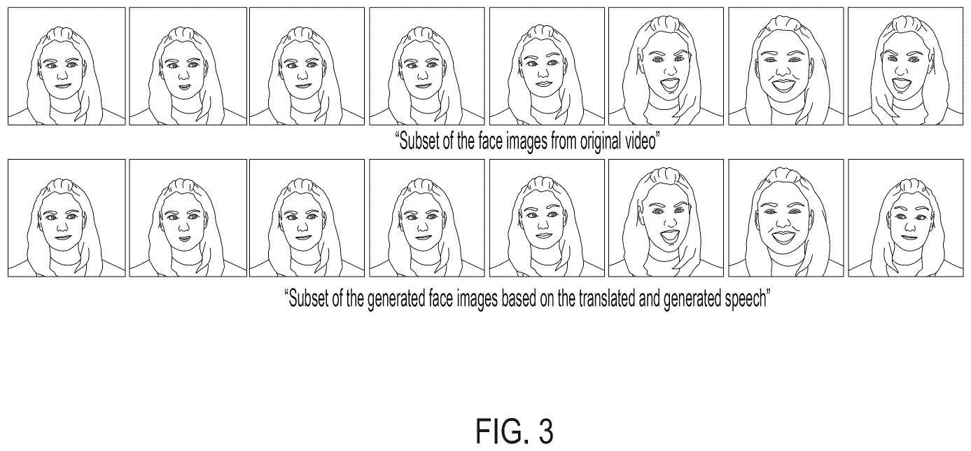

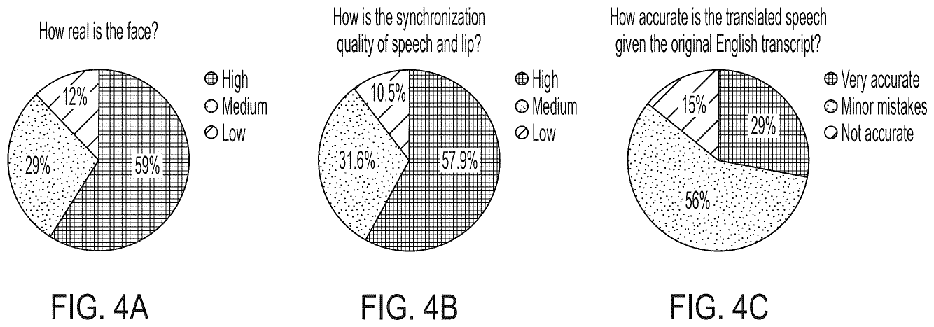

Results of quality of the generated faces, synchronization accuracy, and the translation accuracy are shown in FIGS. 4A-B. The results indicate that participants rate the quality of the generated faces as high. Similarly, the majority of the answers state that the system of the present invention can provide accurate synchronization in the generated videos. For the translation accuracy, although a majority of the answers indicate that there are minor mistakes in the text, only 15% of the answers find the results inaccurate. Moreover, the naturalness and intelligibility results are shown in Table 7. The results demonstrate that the system of the present invention can be successful in providing naturalness and intelligibility in the generated video. The evaluation showed that the faces and lip-synchronization in the generated videos were believable and the generated speech well intelligible. Sample images are shown in FIG. 3. However, occasional problems with naturalness of the generated speech and inaccuracies in the translations were observed due to lacking punctuation in the transcripts generated by the ASR model. Moreover, the lip-syncing model showed slight issues with bearded faces and also had some quality problems that must be addressed to improve the quality of the generated faces to make them more natural.

TABLE 7

| Measurement | Score |
|---|---|
| Naturalness | 3.36 ± 0.98 |
| Intelligibility | 4.24 ± 0.86 |

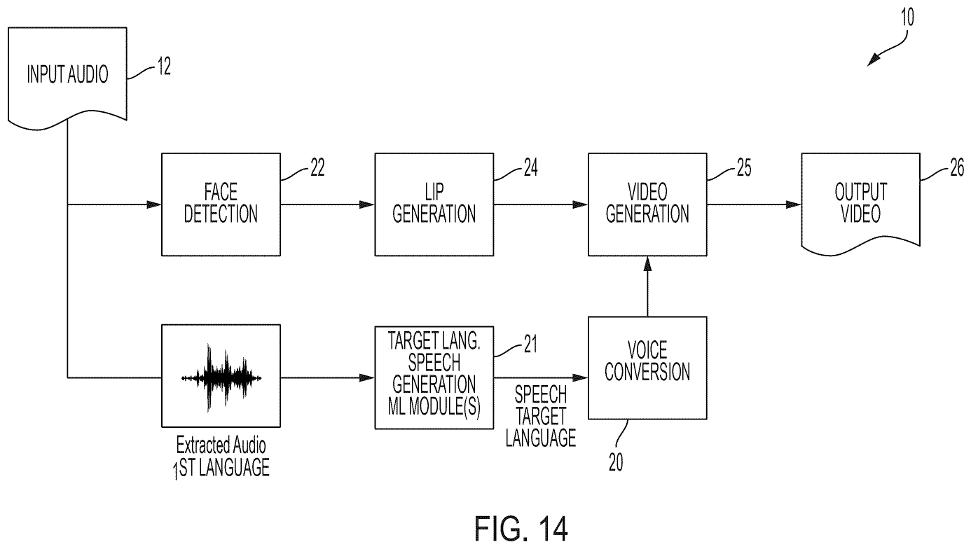

FIG. 14 is a diagram of the multimodal system 10 according to other embodiments of the present invention. The multimodal system 10 of FIG. 14 is similar to that of FIG. 1, except that in FIG. 14, a target language speech generation machine learning module(s) 21 replaces the explicit ASR 14, machine translation 16 and TTS module 18 of FIG. 1 in the audio processing sub-system/pipeline. That is, in the embodiment of FIG. 14, the target language speech generation machine learning module(s) 21 is trained to convert input audio in the first language to audible speech in the target language, without explicit ASR, machine translation and TTS steps as in FIG. 1.

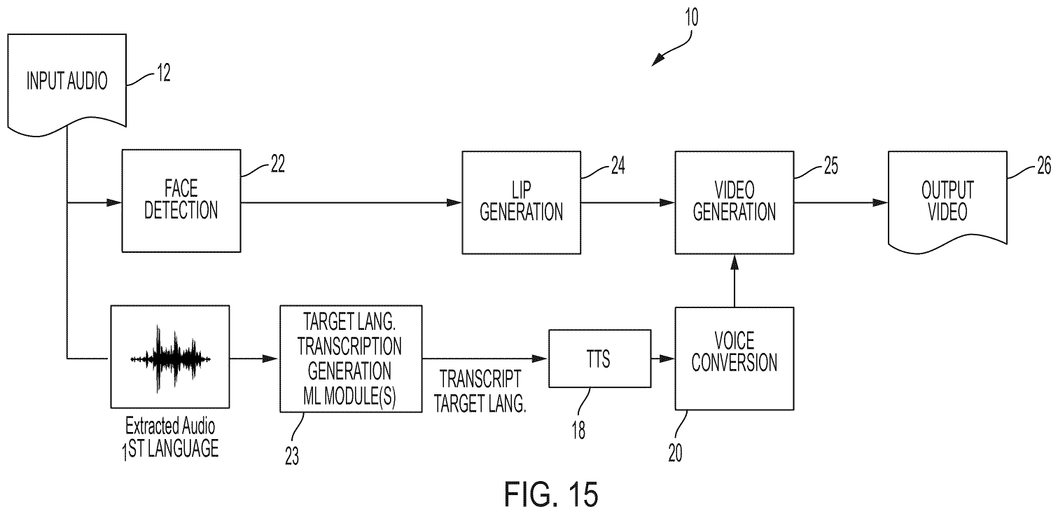

Figure is a diagram of the multimodal system 10 according to other embodiments of the present invention. The multimodal system 10 of FIG. 15 is similar to that of FIG. 1, except that in FIG. 15, a target language transcription generation machine learning module(s) 23 replaces the explicit ASR and machine translation modules 14 of FIG. 1 in the audio processing sub-system/pipeline (but retains the TTS module 18 of FIG. 1). That is, in the embodiment of FIG. 15, the target language transcription generation machine learning module(s) 23 is trained to convert input audio in the first language to a transcription in the target language, without explicit ASR and machine translation steps as in FIG. 1.

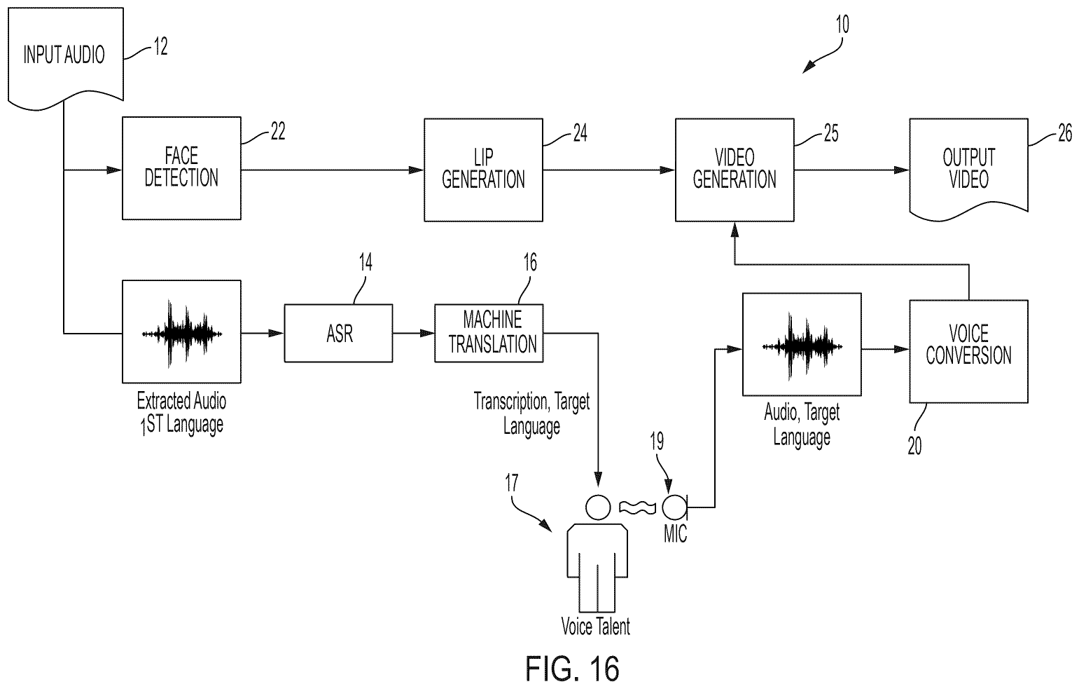

FIG. 16 is a diagram of the multimodal system 10 according to other embodiments of the present invention. The multimodal system 10 of FIG. 16 is similar to that of FIG. 1, except that the TTS module 18 is eliminated. In its place, a person 17 (e.g., a voice talent) enunciates audibly, in the target language, the transcription in the target language from the machine translation module 16. A microphone 19 picks up the person's voice utterances in the target language, which can be extracted an input to the voice conversion module 20.

The end-to-end model provides combined translation of speech and video/speaker adaption to match the translation. Given a video of a speaker, the system can generate a convincing video of that speaker uttering a translation of the original speech while adapting lip movements to the new audio and preserving voice characteristics. Additionally, emphases are preserved by emphasis detection in the ASR model, and modifications to the used FastSpeech 2 TTS model allow fine-grained prosody control which is used to create corresponding emphases in the synthesized speech. To address remaining issues identified in experimental results and to improve naturalness of the generated speech, generation can be improved by controlling the supra-sentential flow and timing. The models described achieve this by taking advantage of automatic insertion of punctuation and voice activity detection to mark appropriate pauses in the transcript during ASR. This information improves translation quality and improves naturalness during the generation. Improvements towards greater robustness in voice conversion model are also desirable as occasional robustness issues on long speech inputs can be observed in early models. These can be improved with additional training data that specifically incorporates long speech samples. Lastly, as the pipeline of the system contains many components, inference times may not operate in real-time if all models are cascaded in sequence. Low-latency face dubbing can also be achieved, however, by improving processing speed, by processing several models in parallel, and by pipelining the architecture as was done for low-latency speech translation subtitling.

The audio of the speaker in the native/original/first spoken language is captured by a microphone. The microphone may have a diaphragm that converts the sound wave from the speaker's utterances to an analog signal, which is converted to digital with a DAC converter, for processing as described herein. The images/video of the speaker may be captured by a digital camera(s), for example. The digital camera may include a megapixel CCD or CMOS image sensor, for example, which measures the color and brightness of each pixel, which are stored as digital values. The microphone(s) and camera(s) can be part of a common “transmitter” device, such as smartphone, tablet computer, laptop, or desktop computer, for example. They could also be separate devices connected to a computer via a data bus.

The final video, with the images/video of the speaker and the voice of the speaker, but in the target (“translated into”) language, is displayed by a device that has a monitor and a speaker. The monitor and speaker can be part of a common “recipient” device, such as smartphone, tablet computer, laptop, or desktop computer, for example. They could also be separate devices connected to a computer via a data bus.

A processor(s) may include the models and/or modules of the audio and video pipelines described herein. The processor(s) receives the digital audio and digital video from the microphone and image sensor, and converts them to the final video as described herein, which is sent to the monitor and speaker of the recipient device. The processor(s) could be on the transmitter device, on the recipient device, and/or on a third, remote device. For example, the transmitter and recipient devices may be connected to, and communicate via, a data network, such as the Internet, a WAN, a LAN, etc. The remote device may be a computer system with a processor(s) that is connected to the data network, such as a cloud computing server, for example.

In one general aspect, therefore, embodiments of the present invention are directed to speech translation system with voice conversion and lip synchronization that captures an input video of a subject speaking in a first language and, based thereon, generates an output video of the speaker with translated audio in a second, different language, and accordingly adapted lip movements while preserving voice characteristics and prosodic emphases of the original audio, including of the speaker. Other variations are also within the scope of the present invention.

In another variation, the present invention is directed to a video generation system that generates a synthetic video from a first video of a first speaker, where the synthetic video retains facial expressions of the first speaker. In such an embodiment, the first speaker is speaking in a first language in the first video, and the synthetic video comprises an audio translation of the first speaker speaking in a second, different language. In other embodiments, both the first and synthetic videos can comprise audio of the first speaker speaking in the same language. In any of these variations, the synthetic video can retain prosodic characteristics of the first speaker in the first video. Also, in the first video the speaker can be speaking in a first language and in the synthetic video the speaker is speaking a second, different language.

In another general aspect, the present invention is directed to a video generation system that generates a video of a speaker speaking in a first language based on received text of speech by the speaker in a second, different language and based on preloaded video of the speaker speaking. That is, there does not need to be an input video, just audio. The output of the voice conversion can be matched with the preloaded video of the speaker. In fact, in various embodiments, the preloaded video does not need even to be of the original speaker. The preloaded video could be of any speaker, real or animated. Also, in various implementations, the text of speech by the speaker in the second language is transmitted to the video generation system via SMS, such as described above. Also, in various embodiments, the lip-synching could be performed with trailing video material, so as to produce face translation incrementally at low latency.

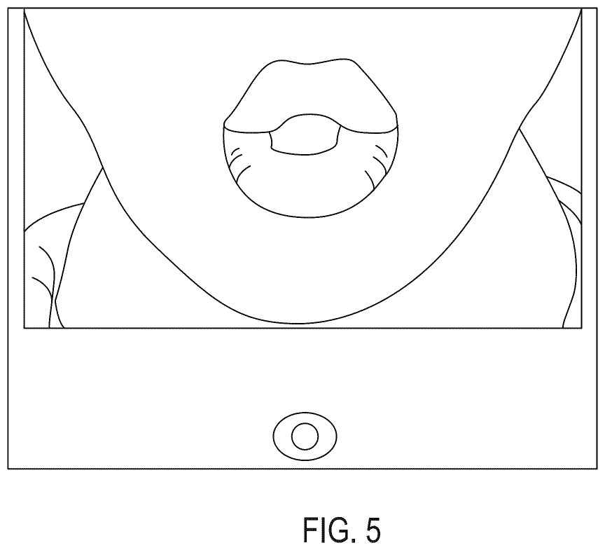

In other embodiments, in addition to or in lieu of generating the synthetic video of the original speaker speaking in the second language, a synthetic video with exaggerated lip movement, with lips from a real or animated person (such as the original speaker, or a different speaker captured in preloaded video, or animated lips) and larger lip video can be generated, such as shown in FIG. 5. The lip generation module 24 can be trained to generate the exaggerated lips in such an embodiment. Such exaggerated lip movement video could aid the hearing impaired in understanding speech. FIG. 5 shows a lip movement video on an output device, such as mobile device. The lip movement video could be shown on the output device along with a video of the speaker from a wider view, showing the whole, or most of, the head of the speaker in the video, or along with the transcript, or along with synthetic sign language generation. The output could also comprise subtitles in the second language and/or sign language (by a real, synthetic or animated person). In combination, these additional modes can assist clarity for hearing impaired or for generation in noisy situations.

In various embodiments, the synthetic video could employ different angles and facial expressions from the original video; and/or it could include frowns, smiles, coughs and sneezes in the synthetic video according to the input video as well. Also, micro-features could be created in the video-generated face in the synthetic video, so that synthetic video reflects the input user's expression. Silence, for example, preferably generates a neutral pose in the output speaker that changes only very slightly or subtly, e.g. eye-blinking, subtle twitching or face motion, etc.

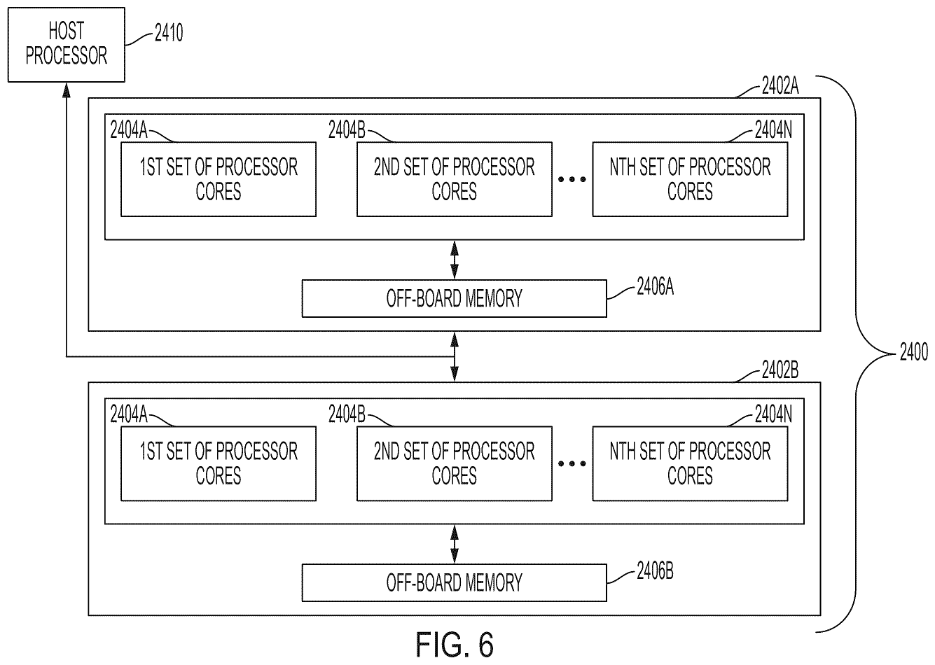

FIG. 6 is a diagram of a computer system computer system 2400 that could be used to implement the embodiments described above. The illustrated computer system 2400 comprises multiple processor units 2402A-B that each comprises, in the illustrated embodiment, multiple (N) sets of processor cores 2404A-N. Each processor unit 2402A-B may comprise onboard memory (ROM or RAM) (not shown) and off-board memory 2406A-B. The onboard memory may comprise primary, volatile, and/or non-volatile storage (e.g., storage directly accessible by the processor cores 2404A-N). The off-board memory 2406A-B may comprise secondary, non-volatile storage (e.g., storage that is not directly accessible by the processor cores 2404A-N), such as ROM, HDDs, SSD, flash, etc. The processor cores 2404A-N may be CPU cores, GPU cores and/or AI accelerator cores. GPU cores operate in parallel (e.g., a general-purpose GPU (GPGPU) pipeline) and, hence, can typically process data more efficiently than a collection of CPU cores, but all the cores of a GPU execute the same code at one time. AI accelerators are a class of microprocessor designed to accelerate artificial neural networks. They typically are employed as a co-processor in a device with a host processor 2410 as well. An AI accelerator typically has tens of thousands of matrix multiplier units that operate at lower precision than a CPU core, such as 8-bit precision in an AI accelerator versus 64-bit precision in a CPU core.

In various embodiments, the different processor cores 2404 may train and/or implement different networks or subnetworks or components of the system 10. For example, in one embodiment, the cores of the first processor unit 2402A may train or implement the ASR module 14; the second processor unit 2402B may train or implement the machine translation module 16; and so on. In other embodiments, one or more of the processor cores 2404 and/or one or more of the processor units could implement other components in the systems herein, such as the TTS 18, voice conversion 20, face detection 22 and/or lip generation 24. One or more host processors 2410 may coordinate and control the processor units 2402A-B.

In other embodiments, the system 2400 could be implemented with one processor unit 2402. In embodiments where there are multiple processor units, the processor units could be co-located or distributed. For example, the processor units 2402 may be interconnected by data networks, such as a LAN, WAN, the Internet, etc., using suitable wired and/or wireless data communication links. Data may be shared between the various processing units 2402 using suitable data links, such as data buses (preferably high-speed data buses) or network links (e.g., Ethernet).

The software for the various machine learning systems described herein and other computer functions described herein may be implemented in computer software using any suitable computer programming language, such as .NET, C, C++, or Python, and using conventional, functional, or object-oriented techniques. For example, the various machine learning systems may be implemented with software modules stored or otherwise maintained in computer readable media, e.g., RAM, ROM, secondary storage, etc. One or more processing cores (e.g., CPU or GPU cores) of the machine learning system may then execute the software modules to implement the function of the respective machine learning system (e.g., student, coach, etc.). Programming languages for computer software and other computer-implemented instructions may be translated into machine language by a compiler or an assembler before execution and/or may be translated directly at run time by an interpreter. Examples of assembly languages include ARM, MIPS, and x86; examples of high-level languages include Ada, BASIC, C, C++, C#, COBOL, Fortran, Java, Lisp, Pascal, Object Pascal, Haskell, ML; and examples of scripting languages include Bourne script, JavaScript, Python, Ruby, Lua, PHP, and Perl.

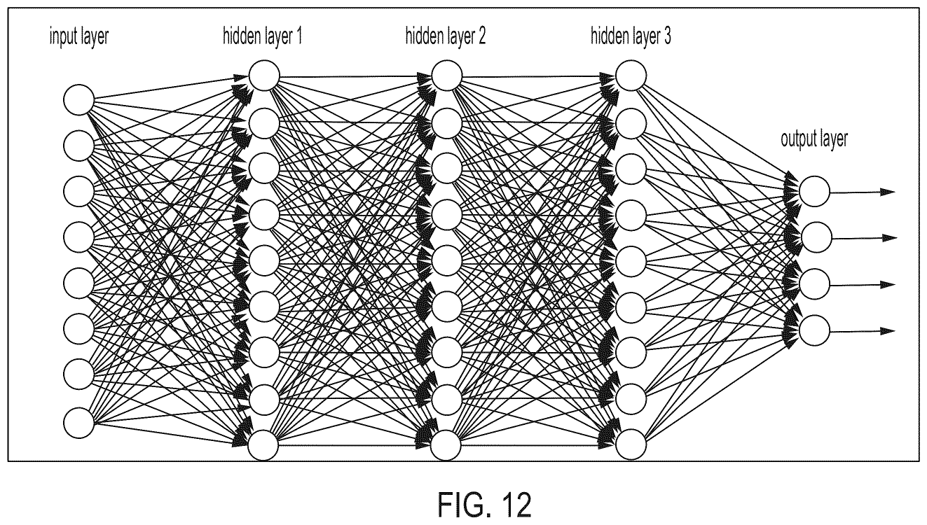

The various machine-learning modules of the system 10 can employ a neural network or multiple neural networks, and particularly deep neural networks. A deep neural network is an artificial neural network with multiple “inner” or “hidden” layers between the input and output layers. FIG. 12 illustrates an example of a multilayer feed-forward deep neural network. A neural network is a collection of nodes and directed arcs. The nodes in a neural network are often organized into layers. In a feed-forward neural network, the layers may be numbered from bottom to top, when diagramed as in FIG. 12. Each directed arc in a layered feed-forward neural network goes from a source node in a lower layer to a destination node in a higher layer. The feed-forward neural network shown in FIG. 12 has an input layer, an output layer, and three inner layers. An inner layer in a neural network is also called a “hidden” layer. Each directed arc is associated with a numerical value called its “weight.” Typically, each node other than an input node is associated with a numerical value called its “bias.” The weights and biases of a neural network are called “learned” parameters. During training, the values of the learned parameters are adjusted by the computer system 2400 shown in FIG. 6. Other parameters that control the training process are called hyperparameters.

A feed-forward neural network may conventionally be trained by the computer system 2400 using an iterative process of stochastic gradient descent with one iterative update of the learned parameters for each minibatch. In stochastic gradient descent, the full batch of training data is typically arranged into a set of smaller, disjoint sets called minibatches. An epoch comprises the computer system 2400 doing a stochastic gradient descent update for each minibatch contained in the full batch of training data. For each minibatch, the computer estimates the gradient of the objective for a training data item by first computing the activation of each node in the network using a feed-forward activation computation. The computer system 2400 then estimates the partial derivatives of the objective with respect to the learned parameters using a process called “back-propagation,” which computes the partial derivatives based on the chain rule of calculus, proceeding backwards through the layers of the network.

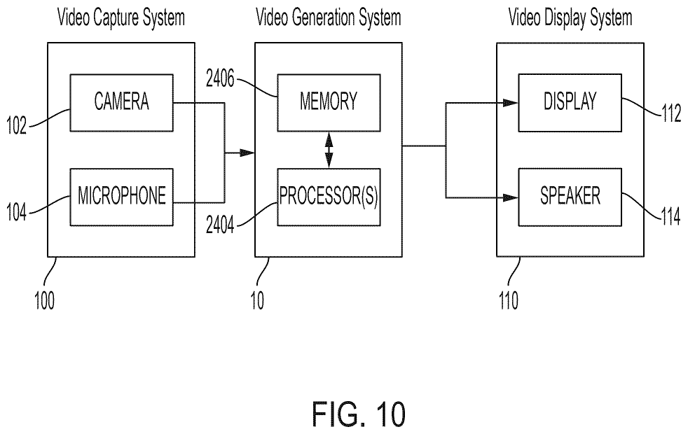

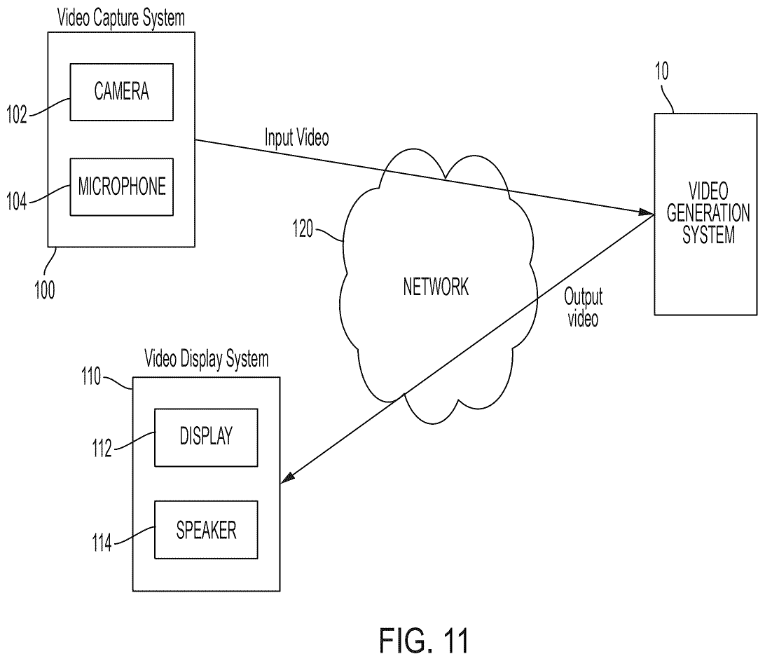

FIGS. 10 and 11 illustrate architectures in which the video generation system 10 of FIG. 1 may be employed according to various embodiments. The video generation system 10 may include a processor(s) 2404 and memory 2406 as described above in connection with FIG. 6. A video capture device 100 captures the input video 12. To that end, the video capture device 100 may comprise a camera(s) 102 for capturing video and a microphone(s) 104 for capturing audio of a speaker speaking. Any suitable video capture device 100 can be used, such as a smartphone, a table computer, a camcorder, a computer equipped with a web camera, etc. The input video 12 could employ a suitable video format such as MP4, MOV, WMV, AVI, Flash video, WEBM, HTML5, MPEG-2, etc. The video generation system 10 generates the output video 26 from the input video 12 as described herein. The output video 26 could any suitable video format such as MP4, MOV, WMV, AVI, Flash video, WEBM, HTML5, MPEG-2, etc. The output video 26 can then be played by a video display device 110, which may include a display 112 and a speaker(s) 114.

The video capture device 100 and/or the video display device 110 may be co-located with the video generation system 10, such as shown in FIG. 10. As such, a high bandwidth cable could connect the video capture device 100 to the video generation system 10, and a high bandwidth video cable (e.g., HDMI) could connect the video generation system 10 to the video display device 110. In other embodiments, the video capture device 100 and/or the video display device 110 may be remote the video generation system 10, such as shown in FIG. 11, in which case the components 10, 100, 110 may be connected via a wired and/or wireless electronic data network(s) 120, such as a LAN(s), a WAN(s), the Internet, etc. In that sense, the video generation system 10 could be a cloud service hosted by a cloud server service(s).

In some applications, the bandwidth of the connection to the video generation system 10 from the video capture device 100 might be too low to send large video files for real time, or near real time, output. In such embodiments, text, without video, of the user's speech may be transmitted from the capture device 100 (which does not need to capture video, but which could instead just capture audio) to the video generation system 10 using a low bandwidth medium, such as, for example, SMS (Short Message Service). As such, the capture device 100 may comprise an ASR module to convert the speech in the input language (e.g., English) by the speaker to text in the input language (e.g., English). The transmitted text could be in the native speaker language (e.g., English), in which case the video generation system 10 converts it to text in the target language (e.g., German). In other embodiments, the capture device could also comprise a machine translation module to convert locally the native speaker language (e.g., English) to the target language (e.g., German), such that the text sent to the video generation system 10 is in the target language. The video generation system 10 in such an embodiments stores pre-loaded, stock video of the speaker speaking. The video generation system 10 can use the pre-loaded video of the speaker to generate video of the speaker speaking in the target language as described herein. The speaker can be speaking any language in the pre-loaded video.

Embodiments of the present invention could also be used as a voice conversion system, such as the multimodal system of FIG. 1 without the video processing pipeline. FIG. 12 is a block diagram of a voice conversion system 130 according to various embodiments of the present invention. As shown in FIG. 12, in such a system 130, the ASR module 14 receives audio 132 of a first speaker speaking in a first language (e.g., English), and generates therefrom a textual transcription in the first language of what the first speaker said in the input audio 132. Then the machine translation module 16 coverts the textual transcription in the first language to a textual transcription in the second/target language (e.g., German). Then the TTS module generates speech in the second/target language, although not necessarily (and unlikely to be) in the voice of the first speaker. Finally, the voice conversion module 20 can adapt to the output of the speech from the TTS module 18 to be output audio 134 from the first speaker in the second/target language. As described herein, the output audio 134 can preserve the prosodic characteristics of the first speaker in the input audio 132. The input audio 132 and output audio 134 may be formatted in a suitable audio format, such as WAV, MP3, AIFF, AAC, OGG, WMA, FLAC, or ALAC, for example.

As is clear from the description above, there are two general operational phases for the machine learning systems 10, 130: a training phase and a deployment phase. In the training phase, the various modules of the systems 10, 130 are trained, such as through machine learning, as described herein. Once the system 10, 130 is trained, it is ready for deployment, in which the system 10, 130 can generate the output video 26 for a give input video 12, or output audio 134 from input audio 132, as the case may be, according to the various techniques and methods described herein. The training phase can generally include training, validation and testing of the machine learning models. Training can also continue in an on-going manner after deployment of the system 10, but each of the machine learning models of the system 10 are preferably trained to a suitable level of performance before deployment commences.

In one general aspect, therefore, the present invention is directed to a speech translation system, and corresponding method, with voice conversion and lip synchronization that captures an input video of a subject speaking in a first language and, based thereon, generates an output video of a speaker with translated audio in a second, different language, and accordingly adapted lip movements while preserving voice characteristics and prosodic emphases of the original audio, including of the subject in the input video. The speaker in the output video, can be, for example the subject in the input video; a different person than the subject in the input video; or an animated character.

In another general aspect, the present invention is directed voice conversion system that generates a transcription in a first language from audio of a first speaker speaking in the first language, generates a translation of the transcription in a second language, generates speech of a second speaker in the second language, and conversion of the speech from the second speaker in the second language to speech from the first speaker in the second language.

In other general aspects, the present invention is directed to a system for generating output audio of an output speaker speaking in a target language from input audio of a first speaker speaking in a first language, where the first language is different from the target language. The system comprises an audio processing sub-system, which comprises: one or more audio-processing machine learning module that are trained through machine learning to generate speech in the target language from speech, in the input audio, in the first language by the first speaker; and a voice conversion module trained, through machine learning, to generate adapted speech in the target language by adapting the speech in the target language from the one or more audio-processing machine learning models to voice characteristics of the first speaker in the input audio.

In various implementations, the one or more audio-processing machine learning models of the audio processing sub-system comprise a text-to-speech module trained, through machine learning, to generate the speech in the target language from a textual translation in the target language of the speech by the first speaker in the first language. Also, the voice conversion module can be trained to generate the adapted speech in the target language by adapting the speech in the target language from the text-to-speech module to the voice characteristics of the first speaker in the input audio.

In various implementations, the one or more audio-processing machine learning models of the audio processing sub-system comprise: an automatic speech recognition module trained, through machine learning, to generate a textual transcription in the first language from the speech, in the input audio, in the first language by the first speaker; and a translation module trained, through machine learning, to generate a textual translation into the target language from the textual transcription of the speech in the first language from the automatic speech recognition module.

In various implementations, the one or more audio-processing machine learning models of the audio processing sub-system further comprise a text-to-speech module trained, through machine learning, to generate the speech in the target language from the textual translation in the target language from the translation module; and the voice conversion module is trained to generate the adapted speech in the target language by adapting the speech in the target language from the text-to-speech module to the voice characteristics of the first speaker in the input audio.

In various implementations, the input audio is part of an input video of the first speaker speaking in the target language, where the input video comprises a face of the first speaker. In such implementations, the system can further comprise a video processing sub-system, which can comprise: a face detection module trained, through machine learning, to detect a face of the first speaker in the input video; a lip generation module trained, through machine learning, to generate, based on the face of the first speaker in the input video from the face detection module and from the adapted speech from the voice conversion module, new video frames of face and lips of the output speaker that are synchronized to the adapted speech from the voice conversion module; and a video generation module that is configured to combine the new video frames from the lip generation module and the adapted speech from the voice conversion module to generate an output video such that movement of the lips of the output speaker in the output video is synchronized to the adapted speech in the target language.

In another general aspect, the present invention is directed to a system for generating an output video of an output speaker from input video of a first speaker, where the first speaker is speaking in a first language in the input video. The system comprises an audio processing sub-system, which comprises a voice conversion module trained, through machine learning, to generated adapted speech in the first language by adapting the speech in the first language in the input video to voice characteristics of the first speaker in the input video. The system also comprises a video processing sub-system, which comprises: a face detection module to detect a face of the first speaker in the input video; a lip generation module trained, through machine learning, to generate, based on the face of the first speaker in the input video from the face detection module and from the adapted speech from the voice conversion module, new video frames of face and lips of the output speaker that are synchronized to the adapted speech from the voice conversion module; and a video generation module that is configured to combine the new video frames from the lip generation module and the adapted speech from the voice conversion module to generate the output video such that movement of the lips of the output speaker in the output video is synchronized to the adapted speech from the voice conversion module.

In various implementations, the output speaker in the output video is the first speaker in the input video; and the output speaker in the output video is speaking in a target language that is different from the first language.

In various implementations, the audio processing sub-system further comprises one or more audio-processing machine learning modules that are trained through machine learning to generate the speech in the target language from speech by the first speaker in the first language from the input audio.

In various implementations, the one or more audio-processing machine learning modules comprise: an automatic speech recognition module trained, through machine learning, to generate a textual transcription of the speech by the first speaker in the first language from the input video; a translation module trained, through machine learning, to generate a textual translation into the target language of the textual transcription of the speech in the first language from the input video; and a text-to-speech module trained, through machine learning, to generate the speech in the target language from the textual translation into the target language. The voice conversion module can be trained to generate the adapted speech in the target language by adapting the speech in the target language from the text-to-speech module to voice characteristics of the first speaker in the input video.

In various implementations, the output speaker in the output video is speaking in the first language.

In various implementations, the output speaker in the output video preserves prosodic characteristics of the first speaker in the input video.

In another general aspect, the present invention is directed to a system for generating an output video of an output speaker speaking in a target language. The system comprises a remote source for capturing input audio by the output speaker in a first language that is different from the target language and converting speech by the output speaker in the input audio into text in the first language. The system also comprises an audio processing sub-system in communication with the remote source, where the audio processing sub-system comprises one or more audio-processing machine learning modules trained through machine learning to generate speech in the target language based on the text in the first language from the remote source, of the speech by the output speaker in a first language that is different from the target language. The audio processing sub-system is configured to receive the text of the speech by the output speaker in the first language from the remote source. A video processing sub-system stores pre-loaded video of the output speaker speaking. The video processing sub-system comprises: a face detection module trained, through machine learning, to detect a face of the output speaker in the pre-loaded video; a lip generation module trained, through machine learning, to generate, based on the face of the output speaker in the pre-loaded video from the face detection module and from the speech in the target language from the one or more audio-processing machine learning modules, new video frames of face and lips of the output speaker that are synchronized to the speech from the one or more audio-processing machine learning modules; and a video generation module that is configured to combine the new video frames from the lip generation module and the speech from the one or more audio-processing machine learning modules to generate the output video.

In various implementations, the one or more audio-processing machine learning modules comprise: a translation module trained, through machine learning, to generate a textual translation into the target language based on the text in the first language from the remote source, of the speech by the output speaker in the first language that is different from the target language; and a text-to-speech module trained, through machine learning, to generate the speech in the target language from the textual translation into the target language.

In various implementations, the text of speech by the speaker in the first language is transmitted from the remote source to the audio processing sub-system via a low bandwidth medium. In various implementations, the low bandwidth medium comprises SMS. In various implementations, the text of the speech by the output speaker is transmitted from the remote source to the audio processing sub-system without video of the speaker making the speech.

In various implementations, the remote source comprises: a microphone for capturing the input audio by the output speaker in the first language; and an automatic speech recognition module trained, through machine learning, to generate the text in the first language from the input audio captured by the microphone.

In various implementations of the prior described systems, the output video preserves voice, prosody and facial characteristics of the first speaker in the input video.

In various implementations, the output video preserves facial expressions of the first speaker in the input video.

In various implementations, the output speaker in the output video is the first speaker in the input video.

In various implementations, the output video comprises a micro-feature of the output speaker that corresponds to a micro-feature of the first speaker in the input video, such that the output speaker in the output video reflects expressions of the first speaker in the input video. The micro-feature may comprise silence, eye-blinking, face twitching, face motion, and/or facial expressions.

In various implementations, the output speaker in the output video is different than the first speaker in the input video. For example, the output speaker may be an animated character.

In various implementations, the output video comprises video of the first speaker in the input video with lip movement generated according to the adapted speech from the voice conversion module, while preserving voice characteristics and prosodic emphases of the first speaker from the input audio in the input video.

In various implementations, the movement of the lips of the output speaker in the output video is exaggerated relative to lip movement of the first speaker in the input video.

In various implementations, the output video comprises: a display of a face of the output speaker; subtitles of text in the target language; and/or a display of hands performing sign language for the adapted speech in the target language in the output video.

In various implementations, the output video comprises angles of the output speaker different from angles of the first speaker in the input video.

In various implementations, the output video comprises different facial expressions for the output speaker than of the first speaker in the input video.

In various implementations, the automatic speech recognition module comprises a long short-term memory model.

In various implementations, the translation module comprises a neural network that comprises a multi-layer encoder and a multi-layer decoder.

In various implementations, the translation module is trained to put emphasis on output tokens in the textual translation corresponding to emphasized input tokens.

In various implementations, the text-to-speech module comprises a neural network that comprises a multi-layer encoder and a multi-layer decoder.

In various implementations, the text-to-speech module is trained to add emphasis tags to the speech in the target language based on tags in a markup language in the textual translation.

In various implementations, the voice conversion module comprises uses vector quantization mutual information voice conversion (VQMIVC).

In various implementations, the voice conversion module comprise a content encoder that produces a content embedding from speech, a speaker encoder that produces a speaker embedding from speech, a pitch encoder that produces prosody embedding from speech, and a decoder that generates from the content, prosody, and speaker embeddings.

In various implementations, the lip generation module comprises a generator trained to synthesize a face image that is synchronized with audio.

In various implementations, the lip generation module comprises an image encoder, an audio encoder, and an image decoder.

In various implementations, the automatic speech recognition module comprises a long short-term memory model; the translation module comprises a neural network that comprises a multi-layer encoder and a multi-layer decoder; the text-to-speech module comprises a neural network that comprises a multi-layer encoder and a multi-layer decoder; and the voice conversion module comprise a content encoder that produces a content embedding from speech, a speaker encoder that produces a speaker embedding from speech, a pitch encoder that produces prosody embedding from speech, and a decoder that generates from the content, prosody, and speaker embeddings.

In various implementations, the translation module comprises a neural network that comprises a multi-layer encoder and a multi-layer decoder; the text-to-speech module comprises a neural network that comprises a multi-layer encoder and a multi-layer decoder; and the lip generation module comprises an image encoder, an audio encoder, and an image decoder.

In another general aspect, the present invention is directed to a method that comprises the step of generating, by one or more audio-processing machine learning modules of a computer system, that is trained through machine learning, speech in a target language from input audio of speech by a first speaker in a first language. The method also comprises the step of generating, by a voice conversion module of the computer system, that is trained through machine learning, adapted speech in the target language by adapting the speech in the target language from the one or more audio-processing machine learning modules. The step of generating the adapted speech can comprise adapting the speech in to target language to voice characteristics of the first speaker in the input audio.

In various implementations, generating the speech in the target language from the input audio of speech by the first speaker in the first language comprises: generating, by an automatic speech recognition module of the computer system, that is trained through machine learning, a textual transcription in the first language of the speech by the first speaker in the first language from input audio; generating, by a translation module of the computer system, that is trained through machine learning, a textual translation into the target language of the textual transcription of the speech in the first language from the input audio, where the target language is different from the first language; and generating, by a text-to-speech module of the computer system, that is trained through machine learning, the speech in the target language from the textual translation into the target language.

In various implementations, the input audio is part of an input video of the first speaker speaking in the target language, where the input video comprises a face of the first speaker. In such circumstances, the method may further comprise the steps of: detecting, by a face detection module of the computer system, a face of the first speaker in the input video; generating, by a lip generation module of the computer system, that is trained through machine learning, based on the face of the first speaker in the input video from the face detection module and from the adapted speech from the voice conversion module, new video frames of face and lips of an output speaker that are synchronized to the adapted speech from the voice conversion module; and combining, by a video generation module of the computer system, the new video frames from the lip generation module and the adapted speech from the voice conversion module to generate an output video such that movement of the lips of the output speaker in the output video is synchronized to the adapted speech in the target language.

In another general aspect, a method according to the present invention comprises the step of generating, by a voice conversion module of a computer system, where the voice conversion module is trained through machine learning, adapted speech in a first language by adapting a speech in the first language in an input video to voice characteristics of a first speaker in the input video. The method also comprises the step of detecting, by a face detection module of the computer system, a face of the first speaker in the input video. The method also comprises the step of generating, by a lip generation module of the computer system, that is trained through machine learning, based on the face of the first speaker in the input video from the face detection module and from the adapted speech from the voice conversion module, new video frames of face and lips of an output speaker that are synchronized to the adapted speech from the voice conversion module. The method also comprises the step of combining, by a video generation module of the computer system, the new video frames from the lip generation module and the adapted speech from the voice conversion module to generate an output video such that movement of the lips of an output speaker in the output video is synchronized to the adapted speech from the voice conversion module.

In another general aspect, a method according to the present invention comprises the step of capturing, by a remote source, input audio by an output speaker in a first language that is different from a target language. The method also comprises the step of converting, by the remote source, speech by the output speaker in the input audio into text in the first language. The method also comprises the step of receiving, via a data network, by a computer system, from the remote source, the text in the first language. The method also comprises the step of storing, in a memory of the computer system, pre-loaded video of an output speaker speaking. The method also comprises the step of generating, by a translation module, trained through machine learning, of the computer system, a textual translation into the target language from the text in the first language from the remote source. The method also comprises the step of generating, by a text-to-speech module, trained through machine learning, of the computer system, speech in the target language from the textual translation into the target language. The method also comprises the step of detecting, by a face detection module of the computer system, a face of the output speaker in the pre-loaded video. The method also comprises the step of generating, by a lip generation module, trained through machine learning, of the computer system, based on the face of the output speaker in the pre-loaded video from the face detection module and from the speech in the target language from the text-to-speech module, new video frames of the face and lips of the output speaker that are synchronized to the speech from the text-to-speech module. The method also comprises the step of combining, by a video generation module of the computer system, the new video frames from the lip generation module and the speech from the text-to-speech module to generate the output video.

In another general aspect, a computer system according to the present invention comprises one or more processor cores and a memory in communication with the one or more processor cores. The memory stores instructions that when executed by the one or more processor cores, cause the one or more processor cores to: train, through machine learning, one or more audio-processing machine learning modules to generate speech in a target language from speech, in input training audio, by a training speaker in a first language; and train, through machine learning, a voice conversion module to generate adapted speech in the target language by adapting the speech in the target language to voice characteristics of the training speaker in the input training audio.

In various implementations, the one or more audio-processing machine learning modules comprise: an automatic speech recognition module that is trained, through machine learning, to generate a textual transcription in the first language of the speech, in the input training audio, by the training speaker in the first language; a translation module that is trained, through machine learning, to generate a textual translation into the target language of the textual transcription of the speech in the first language from the input training audio, where the target language is different from the first language; and a text-to-speech module that is trained through machine learning to generate the speech in the target language from the textual translation into the target language.

In various implementations, the memory further stores instructions that when executed by the one or more processors, cause the one or more processor cores to, after training to acceptable performance levels the automatic speech recognition module, the translation module, the text-to-speech module, and the voice conversion module, in a deployment mode: generate, by the automatic speech recognition module, a deployment-mode textual transcription in the first language of speech by a first speaker in the first language from deployment-mode input audio of the first speaker; generate, by the translation module, a deployment-mode textual translation into the target language of the deployment-mode textual transcription of the speech in the first language by the first speaker from the deployment-mode input audio; generate, by the text-to-speech module, deployment-mode speech in the target language from the deployment-mode textual translation into the target language; and generate, by the voice conversion module, deployment-mode adapted speech in the target language by adapting the deployment-mode speech in the target language from the text-to-speech module to voice characteristics of the training speaker in the deployment-mode input audio.

In various implementations, the memory further stores instructions that when executed by the one or more processors, cause the one or more processor cores to: train, through machine learning, a lip generation module, based on a detected face of the training speaker in input training video of the training speaker, and from the adapted speech from the voice conversion module, new video frames of face and lips of the training speaker that are synchronized to the adapted speech from the voice conversion module; and after training the lip generation module to a suitable level of performance: (i) detecting, by a face detection module, a face of the first speaker in input video of the first speaker; (ii) detecting, by the lip generation module, based on the face of the first speaker in the input video from the face detection module and from the deployment-mode adapted speech from the voice conversion module, new, deployment-mode video frames of face and lips of an output speaker that are synchronized to the deployment-mode adapted speech from the voice conversion module; and (iii) combining, by a video generation module, the new, deployment-mode video frames from the lip generation module and the deployment-mode adapted speech from the voice conversion module to generate a deployment-mode output video such that movement of the lips of the output speaker in the deployment-mode output video is synchronized to the deployment-mode adapted speech in the target language.

In another general aspect, the memory stores instructions that when executed by the one or more processor cores, cause the one or more processor cores to: train, through machine learning, a voice conversion module of a computer system, to generate adapted speech in a first language by adapting a speech in the first language in an input video to voice characteristics of a training speaker in a training input video; train, through machine learning, a lip generation module, to generate, based on a detected face of the training speaker in the training input video, and from the adapted speech from the voice conversion module, new video frames of face and lips of a training output speaker that are synchronized to the adapted speech from the voice conversion module; and after training the voice conversion module and the lip generation module to suitable levels of performance, in a deployment mode: (i) generate, by the voice conversion module, deployment-mode adapted speech in the first language by adapting a speech in the first language in a deployment-mode input video to voice characteristics of a first deployment-mode speaker in a deployment-mode input video; (ii) detect, by a face detection module, a face of the first deployment-mode speaker in the deployment-mode input video; (iii) generate, by the lip generation module, based on the face of the first deployment-mode speaker in the deployment-mode input video from the face detection module and from the deployment-mode adapted speech from the voice conversion module, new, deployment-mode video frames of face and lips of a deployment-mode output speaker that are synchronized to the deployment-mode adapted speech from the voice conversion module; and (iv) combine, by a video generation module, the new, deployment-mode video frames from the lip generation module and the deployment-mode adapted speech from the voice conversion module to generate a deployment-mode output video such that movement of the lips of the deployment-mode output speaker in the deployment-mode output video is synchronized to the deployment-mode adapted speech from the voice conversion module.

In another general aspect, a system according to the present invention comprises a remote source for capturing input audio by an output speaker in a first language that is different from a target language; and converting speech by the output speaker in the input audio into text in the first language. The system also comprises a computer system in communication with the remote source via a data network. The computer system comprises one or more processor cores, and a memory in communication with the one or more processor cores. The memory stores pre-loaded video of the output speaker speaking. The memory also stores instructions that when executed by the one or more processor cores, cause the one or more processor cores to: generate a textual translation into a target language from the text in the first language from the remote source; generate speech in the target language from the textual translation into the target language; detect a face of the output speaker in the pre-loaded video of the output speaker; generate, based on the face of the output speaker in the pre-loaded video and from the speech in the target language, new video frames of the face and lips of the output speaker that are synchronized to the speech in the target language; and combine the new video frames and the speech in the target language to generate an output video of the output speaker speaking in the target language.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A system for generating output audio of an output speaker speaking in a target language from input audio of a first speaker speaking in a first language, wherein the first language is different from the target language, the system comprising an audio processing sub-system, wherein the audio processing sub-system comprises:
one or more audio-processing machine learning models that are trained through machine learning to generate speech in the target language from speech, in the input audio, in the first language by the first speaker; and
a voice conversion module trained, through machine learning, to generate adapted speech in the target language by adapting the speech in the target language from the one or more audio-processing machine learning models to voice characteristics of the first speaker in the input audio, wherein the voice characteristics comprise pitch, duration and/or energy of speech by the first speaker in the input audio.

2. The system of claim 1, wherein:
the one or more audio-processing machine learning models of the audio processing sub-system comprise a text-to-speech module trained, through machine learning, to generate the speech in the target language from a textual translation in the target language of the speech by the first speaker in the first language; and
the voice conversion module is trained to generate the adapted speech in the target language by adapting the speech in the target language from the text-to-speech module to the voice characteristics of the first speaker in the input audio.

3. The system of claim 1, wherein the one or more audio-processing machine learning models of the audio processing sub-system comprise:
an automatic speech recognition module trained, through machine learning, to generate a textual transcription in the first language from the speech, in the input audio, in the first language by the first speaker; and
a translation module trained, through machine learning, to generate a textual translation into the target language from the textual transcription of the speech in the first language from the automatic speech recognition module.

4. The system of claim 3, wherein:
the one or more audio-processing machine learning models of the audio processing sub-system further comprise a text-to-speech module trained, through machine learning, to generate the speech in the target language from the textual translation in the target language from the translation module; and
the voice conversion module is trained to generate the adapted speech in the target language by adapting the speech in the target language from the text-to-speech module to the voice characteristics of the first speaker in the input audio.

5. The system of claim 1, wherein:
the input audio is part of an input video of the first speaker speaking in the target language, wherein the input video comprises a face of the first speaker; and
the system further comprises a video processing sub-system, wherein the video processing sub-system comprises:
a face detection module trained, through machine learning, to detect a face of the first speaker in the input video;
a lip generation module trained, through machine learning, to generate, based on the face of the first speaker in the input video from the face detection module and from the adapted speech from the voice conversion module, new video frames of face and lips of the output speaker that are synchronized to the adapted speech from the voice conversion module; and
a video generation module that is configured to combine the new video frames from the lip generation module and the adapted speech from the voice conversion module to generate an output video such that movement of the lips of the output speaker in the output video is synchronized to the adapted speech in the target language.

6. A system for generating an output video of an output speaker from input video of a first speaker, wherein the first speaker is speaking in a first language in the input video, the system comprising:
an audio processing sub-system, where the audio processing sub-system comprises a voice conversion module trained, through machine learning, to generate adapted speech in the first language by adapting the speech in the first language in the input video to voice characteristics of the first speaker in the input video, wherein the voice characteristics comprise pitch, duration and/or energy of speech of the first speaker in the input video; and
a video processing sub-system, wherein the video processing sub-system comprises:
a face detection module to detect a face of the first speaker in the input video;
a lip generation module trained, through machine learning, to generate, based on the face of the first speaker in the input video from the face detection module and from the adapted speech from the voice conversion module, new video frames of face and lips of the output speaker that are synchronized to the adapted speech from the voice conversion module; and
a video generation module that is configured to combine the new video frames from the lip generation module and the adapted speech from the voice conversion module to generate the output video such that movement of the lips of the output speaker in the output video is synchronized to the adapted speech from the voice conversion module.

7. The system of claim 6, wherein:
the output speaker in the output video is the first speaker in the input video; and
the output speaker in the output video is speaking in a target language that is different from the first language.

8. The system of claim 7, wherein the audio processing sub-system further comprises one or more audio-processing machine learning modules that are trained through machine learning to generate the speech in the target language from speech by the first speaker in the first language from the input audio.

9. The system of claim 8, wherein the one or more audio-processing machine learning modules comprise:
an automatic speech recognition module trained, through machine learning, to generate a textual transcription of the speech by the first speaker in the first language from the input video;
a translation module trained, through machine learning, to generate a textual translation into the target language of the textual transcription of the speech in the first language from the input video; and
a text-to-speech module trained, through machine learning, to generate the speech in the target language from the textual translation into the target language; and
wherein the voice conversion module is trained to generate the adapted speech in the target language by adapting the speech in the target language from the text-to-speech module to voice characteristics of the first speaker in the input video.

10. The system of claim 6, the output speaker in the output video is speaking in the first language.

11. The system of any of claim 7, 8, 9 or 10, wherein the output speaker in the output video preserves prosodic characteristics of the first speaker in the input video.

12. A system for generating an output video of an output speaker speaking in a target language, the system comprising:
a remote source for capturing input audio by the output speaker in a first language that is different from the target language and converting speech by the output speaker in the input audio into text in the first language;
an audio processing sub-system in communication with the remote source, wherein the audio processing sub-system comprises one or more audio-processing machine learning modules trained through machine learning to generate speech in the target language based on the text in the first language from the remote source, of the speech by the output speaker in a first language that is different from the target language, wherein the audio processing sub-system is configured to receive the text of the speech by the output speaker in the first language from the remote source; and
a video processing sub-system storing pre-loaded video of the output speaker speaking, wherein the pre-loaded video of the output speaker speaking is captured prior to the remote source capturing the input audio by the output speaker in the first language, and wherein the video processing sub-system comprises:
a face detection module trained, through machine learning, to detect a face of the output speaker in the pre-loaded video;
a lip generation module trained, through machine learning, to generate, based on the face of the output speaker in the pre-loaded video from the face detection module and from the speech in the target language from the one or more audio-processing machine learning modules, new video frames of face and lips of the output speaker that are synchronized to the speech from the one or more audio-processing machine learning modules; and
a video generation module that is configured to combine the new video frames from the lip generation module and the speech from the one or more audio-processing machine learning modules to generate the output video.

13. The system of claim 12, wherein the one or more audio-processing machine learning modules comprises:
a translation module trained, through machine learning, to generate a textual translation into the target language based on the text in the first language from the remote source, of the speech by the output speaker in the first language that is different from the target language; and
a text-to-speech module trained, through machine learning, to generate the speech in the target language from the textual translation into the target language.

14. The system of claim 12, wherein the text of speech by the speaker in the first language is transmitted from the remote source to the audio processing sub-system via a low bandwidth medium.

15. The system of claim 14, wherein the low bandwidth medium comprises SMS.

16. The system of claim 14, wherein the text of the speech by the output speaker is transmitted from the remote source to the audio processing sub-system without video of the speaker making the speech.

17. The system of claim 14, wherein the remote source comprises:
a microphone for capturing the input audio by the output speaker in the first language; and
an automatic speech recognition module trained, through machine learning, to generate the text in the first language from the input audio captured by the microphone.

18. The system of any of claim 5, claim 6 or claim 12, wherein the output video preserves voice, prosody and facial characteristics of the first speaker in the input video.

19. The system of claim 18, wherein the output video preserves facial expressions of the first speaker in the input video.

20. The system of any of claim 5 or claim 6, wherein the output speaker in the output video is the first speaker in the input video.

21. The system of claim 20, where output video comprises a micro-feature of the output speaker that corresponds to a micro-feature of the first speaker in the input video, such that the output speaker in the output video reflects expressions of the first speaker in the input video.

22. The system of claim 21, wherein the micro-feature comprises silence, eye-blinking, face twitching, face motion, and facial expressions.

23. The system of any of claim 5 or claim 6, wherein the output speaker in the output video is different than the first speaker in the input video.

24. The system of claim 23, wherein the output speaker is an animated character.

25. The system of any of claim 5 or claim 6, wherein the output video comprises video of the first speaker in the input video with lip movement generated according to the adapted speech from the voice conversion module, while preserving voice characteristics and prosodic emphases of the first speaker from the input audio in the input video.

26. The system of any of claim 5 or claim 7, wherein the movement of the lips of the output speaker in the output video are exaggerated relative to lip movement of the first speaker in the input video.

27. The system of claim 26, wherein the output video comprises:
a display of a face of the output speaker;
subtitles of text in the target language; and/or
a display of hands performing sign language for the adapted speech in the target language in the output video.

28. The system of any of claim 5 or claim 6, wherein the output video comprises angles of the output speaker different from angles of the first speaker in the input video.

29. The system of any of claim 5 or claim 6, wherein the output video comprises different facial expressions for the output speaker than of the first speaker in the input video.

30. The system of any of claim 3 or 9, wherein the automatic speech recognition module comprises a long short-term memory model.

31. The system of any of claim 3, 9 or 13, wherein the translation module comprises a neural network that comprises a multi-layer encoder and a multi-layer decoder.

32. The system of any of claim 3, 9, or 13, wherein the translation module is trained to put emphasis on output tokens in the textual translation corresponding to emphasized input tokens.

33. The system of any of claim 2, 4, 9 or 13, wherein the text-to-speech module comprises a neural network that comprises a multi-layer encoder and a multi-layer decoder.

34. The system of any of claim 2, 4, 9 or 13, wherein the text-to-speech module is trained to add emphasis tags to the speech in the target language based on tags in a markup language in the textual translation.

35. The system of any of claim 1, 2, 3, 4, 5, or 6, wherein the voice conversion module uses vector quantization mutual information voice conversion (VQMIVC).

36. The system of claim 35, wherein the voice conversion module comprise a content encoder that produces a content embedding from speech, a speaker encoder that produces a speaker embedding from speech, a pitch encoder that produces prosody embedding from speech, and a decoder that generates from the content, prosody, and speaker embeddings.

37. The system of claim 5, 6 or 12, wherein the lip generation module comprises a generator trained to synthesize a face image that is synchronized with audio.

38. The system of claim 37, wherein the lip generation module comprises an image encoder, an audio encoder, and an image decoder.

39. The system of claim 4, wherein:
the automatic speech recognition module comprises a long short-term memory model;
the translation module comprises a neural network that comprises a multi-layer encoder and a multi-layer decoder;
the text-to-speech module comprises a neural network that comprises a multi-layer encoder and a multi-layer decoder; and
the voice conversion module comprise a content encoder that produces a content embedding from speech, a speaker encoder that produces a speaker embedding from speech, a pitch encoder that produces prosody embedding from speech, and a decoder that generates from the content, prosody, and speaker embeddings.

40. The system of claim 13, wherein:
the translation module comprises a neural network that comprises a multi-layer encoder and a multi-layer decoder;
the text-to-speech module comprises a neural network that comprises a multi-layer encoder and a multi-layer decoder; and
the lip generation module comprises an image encoder, an audio encoder, and an image decoder.

41. A method comprising:
generating, by one or more audio-processing machine learning modules of a computer system, that is trained through machine learning, speech in a target language from input audio of speech by a first speaker in a first language; and
generating, by a voice conversion module of the computer system, that is trained through machine learning, adapted speech in the target language by adapting the speech in the target language from the one or more audio-processing machine learning modules, wherein generating the adapted speech comprises adapting the speech in to target language to voice characteristics of the first speaker in the input audio, wherein the voice characteristics comprise pitch, duration and/or energy of speech of the first speaker in the input audio.

42. The method of claim 41, wherein generating the speech in the target language from the input audio of speech by the first speaker in the first language comprises:
generating, by an automatic speech recognition module of the computer system, that is trained through machine learning, a textual transcription in the first language of the speech by the first speaker in the first language from input audio;
generating, by a translation module of the computer system, that is trained through machine learning, a textual translation into the target language of the textual transcription of the speech in the first language from the input audio, wherein the target language is different from the first language; and
generating, by a text-to-speech module of the computer system, that is trained through machine learning, the speech in the target language from the textual translation into the target language.

43. The method of any of claim 41 or 42, wherein:
the input audio is part of an input video of the first speaker speaking in the target language, wherein the input video comprises a face of the first speaker; and
the method further comprises:
detecting, by a face detection module of the computer system, a face of the first speaker in the input video;
generating, by a lip generation module of the computer system, that is trained through machine learning, based on the face of the first speaker in the input video from the face detection module and from the adapted speech from the voice conversion module, new video frames of face and lips of an output speaker that are synchronized to the adapted speech from the voice conversion module; and
combining, by a video generation module of the computer system, the new video frames from the lip generation module and the adapted speech from the voice conversion module to generate an output video such that movement of the lips of the output speaker in the output video is synchronized to the adapted speech in the target language.

44. A method comprising:
generating, by a voice conversion module of a computer system, where the voice conversion module is trained through machine learning, adapted speech in a first language by adapting a speech in the first language in an input video to voice characteristics of a first speaker in the input video, wherein the voice characteristics comprise pitch, duration and/or energy of speech of the first speaker in the input video;
detecting, by a face detection module of the computer system, a face of the first speaker in the input video;
generating, by a lip generation module of the computer system, that is trained through machine learning, based on the face of the first speaker in the input video from the face detection module and from the adapted speech from the voice conversion module, new video frames of face and lips of an output speaker that are synchronized to the adapted speech from the voice conversion module; and
combining, by a video generation module of the computer system, the new video frames from the lip generation module and the adapted speech from the voice conversion module to generate an output video such that movement of the lips of an output speaker in the output video is synchronized to the adapted speech from the voice conversion module.

45. A method comprising:
capturing, by a remote source, input audio by an output speaker in a first language that is different from a target language;
converting, by the remote source, speech by the output speaker in the input audio into text in the first language;
receiving, via a data network, by a computer system, from the remote source, the text in the first language;
storing, in a memory of the computer system, pre-loaded video of an output speaker speaking, wherein the pre-loaded video of the output speaker speaking is captured prior to the remote source capturing the input audio by the output speaker in the first language, and;
generating, by a translation module, trained through machine learning, of the computer system, a textual translation into the target language from the text in the first language from the remote source;
generating, by a text-to-speech module, trained through machine learning, of the computer system, speech in the target language from the textual translation into the target language;
detecting, by a face detection module of the computer system, a face of the output speaker in the pre-loaded video;
generating, by a lip generation module, trained through machine learning, of the computer system, based on the face of the output speaker in the pre-loaded video from the face detection module and from the speech in the target language from the text-to-speech module, new video frames of the face and lips of the output speaker that are synchronized to the speech from the text-to-speech module; and
combining, by a video generation module of the computer system, the new video frames from the lip generation module and the speech from the text-to-speech module to generate the output video.

46. A computer system comprising:
one or more processor cores; and
a memory in communication with the one or more processor cores, wherein the memory stores instructions that when executed by the one or more processor cores, cause the one or more processor cores to:
train, through machine learning, one or more audio-processing machine learning modules to generate speech in a target language from speech, in input training audio, by a training speaker in a first language; and
train, through machine learning, a voice conversion module to generate adapted speech in the target language by adapting the speech in the target language to voice characteristics of the training speaker in the input training audio, wherein the voice characteristics comprise pitch, duration and/or energy of speech of the training speaker in the input training audio.

47. The computer system of claim 46, wherein the one or more audio-processing machine learning modules comprise:
an automatic speech recognition module that is trained, through machine learning, to generate a textual transcription in the first language of the speech, in the input training audio, by the training speaker in the first language;
a translation module that is trained, through machine learning, to generate a textual translation into the target language of the textual transcription of the speech in the first language from the input training audio, wherein the target language is different from the first language; and
a text-to-speech module that is trained through machine learning to generate the speech in the target language from the textual translation into the target language.

48. The computer system of claim 47, wherein the memory further stores instructions that when executed by the one or more processors, cause the one or more processor cores to, after training to acceptable performance levels the automatic speech recognition module, the translation module, the text-to-speech module, and the voice conversion module, in a deployment mode:
generate, by the automatic speech recognition module, a deployment-mode textual transcription in the first language of speech by a first speaker in the first language from deployment-mode input audio of the first speaker;
generate, by the translation module, a deployment-mode textual translation into the target language of the deployment-mode textual transcription of the speech in the first language by the first speaker from the deployment-mode input audio;
generate, by the text-to-speech module, deployment-mode speech in the target language from the deployment-mode textual translation into the target language; and
generate, by the voice conversion module, deployment-mode adapted speech in the target language by adapting the deployment-mode speech in the target language from the text-to-speech module to voice characteristics of the training speaker in the deployment-mode input audio.

49. The computer system of claim 46, wherein the memory further stores instructions that when executed by the one or more processors, cause the one or more processor cores to:
train, through machine learning, a lip generation module, based on a detected face of the training speaker in input training video of the training speaker, and from the adapted speech from the voice conversion module, new video frames of face and lips of the training speaker that are synchronized to the adapted speech from the voice conversion module; and
after training the lip generation module to a suitable level of performance:
detect, by a face detection module, a face of the first speaker in input video of the first speaker;
detect, by the lip generation module, based on the face of the first speaker in the input video from the face detection module and from deployment-mode adapted speech from the voice conversion module, new, deployment-mode video frames of face and lips of an output speaker that are synchronized to the deployment-mode adapted speech from the voice conversion module; and
combine, by a video generation module, the new, deployment-mode video frames from the lip generation module and the deployment-mode adapted speech from the voice conversion module to generate a deployment-mode output video such that movement of the lips of the output speaker in the deployment-mode output video is synchronized to the deployment-mode adapted speech in the target language.

50. A computer system comprising:
one or more processor cores; and
a memory in communication with the one or more processor cores, wherein the memory stores instructions that when executed by the one or more processor cores, cause the one or more processor cores to:
train, through machine learning, a voice conversion module of a computer system, to generate adapted speech in a first language by adapting a speech in the first language in an input video to voice characteristics of a training speaker in a training input video, wherein the voice characteristics comprise pitch, duration and/or energy of speech of the training speaker in the training input audio;
train, through machine learning, a lip generation module, to generate, based on a detected face of the training speaker in the training input video, and from the adapted speech from the voice conversion module, new video frames of face and lips of a training output speaker that are synchronized to the adapted speech from the voice conversion module; and
after training the voice conversion module and the lip generation module to suitable levels of performance, in a deployment mode:
generate, by the voice conversion module, deployment-mode adapted speech in the first language by adapting a speech in the first language in a deployment-mode input video to voice characteristics of a first deployment-mode speaker in a deployment-mode input video;
detect, by a face detection module, a face of the first deployment-mode speaker in the deployment-mode input video;
generate, by the lip generation module, based on the face of the first deployment-mode speaker in the deployment-mode input video from the face detection module and from the deployment-mode adapted speech from the voice conversion module, new, deployment-mode video frames of face and lips of a deployment-mode output speaker that are synchronized to the deployment-mode adapted speech from the voice conversion module; and
combine, by a video generation module, the new, deployment-mode video frames from the lip generation module and the deployment-mode adapted speech from the voice conversion module to generate a deployment-mode output video such that movement of the lips of the deployment-mode output speaker in the deployment-mode output video is synchronized to the deployment-mode adapted speech from the voice conversion module.

51. A system comprising:
a remote source for:
capturing input audio by an output speaker in a first language that is different from a target language; and
converting speech by the output speaker in the input audio into text in the first language;
a computer system in communication with the remote source via a data network, wherein the computer system comprises:
one or more processor cores; and
a memory in communication with the one or more processor cores, wherein the memory stores:
pre-loaded video of the output speaker speaking, wherein the pre-loaded video of the output speaker speaking is captured prior to the remote source capturing the input audio by the output speaker in the first language; and
instructions that when executed by the one or more processor cores, cause the one or more processor cores to:
generate a textual translation into a target language from the text in the first language from the remote source;
generate speech in the target language from the textual translation into the target language;
detect a face of the output speaker in the pre-loaded video of the output speaker;
generate, based on the face of the output speaker in the pre-loaded video and from the speech in the target language, new video frames of the face and lips of the output speaker that are synchronized to the speech in the target language; and
combine the new video frames and the speech in the target language to generate an output video of the output speaker speaking in the target language.

52. The system of any of claims 1 through 10, wherein the voice characteristics comprise the pitch, duration and energy of speech by the first speaker in the input audio.

53. The method of any of claim 41, 42 or 44, wherein the voice characteristics comprise the pitch, duration and energy of speech by the first speaker in the input audio.

54. The system of any of claims 1 through 10, wherein the voice conversion module comprises:
a content encoder that produces a content embedding from speech;
a speaker encoder that produces a speaker embedding from speech;
a pitch encoder that produces prosody embedding from speech; and
at least one decoder.

55. The system of any of claim 1, 2, 3, 4, 5, 8, or 9, wherein at least one of the one or more audio-processing machine learning models comprises a transformer neural network.

56. The system of any of claim 3, 4, 9 or 17, wherein the automatic speech recognition module comprises a transformer neural network.

57. The system of any of claim 3, 4, 9 or 13, wherein the translation module comprises a transformer neural network.

58. The method of any of claim 41, 42 or 44, wherein the voice conversion module comprises:
a content encoder that produces a content embedding from speech;
a speaker encoder that produces a speaker embedding from speech;
a pitch encoder that produces prosody embedding from speech; and
at least one decoder.

59. The method of claim 41 or claim 42, wherein at least one of the one or more audio-processing machine learning models comprises a transformer neural network.
